(19) United States
(12) Patent Application Publication
(10) Pub. No.: US 2005/0045064 A1
(43) Pub. Date: Mar. 3, 2005

(54) Cellulose acylate film for optical use, and producing method thereof

(75) Inventor: Toyohisa Oya, Minami-ashigara-shi (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 10/924,820

(22) Filed: Aug. 25, 2004

(30) Foreign Application Priority Data
Aug. 26, 2003 (JP) 2003-301344

(51) Int. Cl. C09K 19/00

(52) U.S. Cl. 106/170.27; 428/1.31

(57) ABSTRACT

A cellulose acylate film for optical use that contains a cellulose acylate (a), wherein the cellulose acylate (a) is a mixed ester esterified both acyl and carbamoyl groups, in which the acyl group is an aliphatic acyl group having 2 to 22 carbon atoms, and the carbamoyl group is an alkyl carbamoyl group having 2 to 24 carbon atoms.

### FIELD OF THE INVENTION

The present invention relates to a cellulose acylate film having excellent optical properties, which is useful for an image display device or a silver halide photosensitive material; and to a process for producing the film.

### BACKGROUND OF THE INVENTION

Hitherto, a halogen-containing hydrocarbon, such as dichloromethane, has been used as an organic solvent for a cellulose acylate, when forming a cellulose acylate film to be used in a silver halide photosensitive material or in a liquid crystal image display device. Dichloromethane (boiling point, about 40° C.) has been conventionally used as a good solvent for cellulose acylate. Dichloromethane is a preferable solvent due to its advantage of easy drying in film-forming and drying steps in production process, because it has a low boiling point. In recent years, as to halogen-series organic solvents having a low boiling point, leakage thereof has been remarkably reduced in the step of handling the solvents, even in airtight facilities, from the viewpoint of protecting the environment. For example, an exhaustive closed system to prevent leakage from the system has been developed. Even if the organic solvent is leaked, the following method is adopted to prevent the solvent from being discharged outdoors: installing a gas-absorbing tower to absorb the organic solvent, and treating the solvent before discharge. This method also has been improved. Furthermore, before discharge, the chlorine-containing organic solvent is decomposed by burning based on thermal power, or by action of electron beams. In this way, the organic solvent has hardly been discharged outdoors. However, it is necessary to conduct further research to attain complete prevention of discharge.

Attempts have been made to find solvents for cellulose acylate that are different from dichloromethane, which has been favorably used as a halogen-series organic solvent. Examples of known organic solvents in which cellulose acylate, in particular cellulose triester, can be dissolved include acetone (boiling point, 56° C.), methyl acetate (boiling point, 56° C.), tetrahydrofuran (boiling point, 65° C.), 1,3-dioxolane (boiling point, 75° C.), and 1,4-dioxane (boiling point, 101° C.) (for example, see Makromol. chem., vol. 143, p.105, 1971 (J. M. G. Cowie et al.), and “Sansakusannserurose no Asetonn Yoeki karano Kannshiki Boushi,” Sennikikai Gakkaishi, 1981, Vol. 34, pp. 57 to 61, (Kenji Kamide et al.)). However, from the viewpoint of practical use, these organic solvents lack sufficient solubility to dissolve cellulose acylate (particularly cellulose triacetate) if conventional dissolving methods are used.

When cellulose acylates (for example, cellulose acetates having an acetyl substitution degree of from 1.5 to 3, which are called cellulose diacetate and cellulose triacetate) are used, for example, as polarizing-plate protective films, and the films are used under crucial conditions of high temperature and high humidity, the degree of polarization of the polarizing plate sometimes reduces depending on moisture permeability of the film. In addition, a change of optical anisotropy is sometimes caused by a dimensional change due to moisture absorption and a change of optical properties resulting from the dimensional change. As a result, such a change of optical anisotropy sometimes adversely affects the performance of articles, when cellulose acylate is used as optical films, in particular.

As cellulose acylate, various cellulose esters, such as cellulose diacetate, cellulose triacetate, cellulose acetate propionate, and cellulose acetate butylate, have been industrially produced. When cellulose acylate films are produced from these known cellulose acylates by the solution film-producing method, there are problems intrinsic to the structure of the cellulose acylate, as mentioned below. Therefore, it has been difficult to impart fully satisfactory properties to the films.

Taking cellulose diacetate as an example, it has wider solvent selectivity than cellulose triacetate, so that cellulose diacetate also has solubility to non-halogen-series organic solvents, such as acetone, but there are some problems originating from cellulose diacetate's high moisture permeability. Therefore, it is difficult, in fact, to use cellulose diacetate as an optical film.

Cellulose triacetate is superior to cellulose diacetate in terms of moisture permeability. However, particularly when cellulose triacetate films are used under crucial conditions of high temperature and high humidity, its moisture permeability sometimes causes problems. In addition, optical anisotropy of the film (for example, values of retardation in the thickness direction) becomes large depending on the film production conditions. Accordingly, various means related to the process are sometimes needed to realize stable production of cellulose triacetate films suitable for optical films.

As to the compounds introduced with a long-chain acyl group, such as cellulose acetate butyrate, solubility to non-halogen-series organic solvents is improved, and moisture permeability is lowered and also improved. However, because its glass transition temperature (Tg) tends to lower, a problem arises because the low Tg makes it difficult to produce a film and to dry the film. The problem is particularly serious with use for optical films. For example, if the glass transition temperature is too low, such problems arise as that the dimensional stability of the film is impaired in the drying process during the film production, and the optical properties of the film change with storage under a high-temperature condition.

As to the cellulose derivatives, mixed esters esterified with both acyl and carbamoyl groups are also known. For example, EP 985682A1 and WO 96/00735 disclose cellulose(3,5-diphenylcarbamate.10-undecenoate), and the like, as chromatography carriers for division of optical isomers. U.S. Pat. No. 6,365,185 discloses cellulose acetate.ethylcarbamate and cellulose acetate.methylcarbamate as materials for a biodegradable drug delivery system. Cellulose acetate.phenylcarbamate as a membrane material for dialysis is disclosed in Diamantoglou M., et al., Cellulose Carbamate and Derivatives as Homocompatible Membrane Materials for Hemodialysis, Artificial Organs, 1999, Vol. 23(1), pp. 15 to 22.

However, the field of application to these materials is completely different from optical use. In addition, it is unknown from these publications about the optical properties of film formed from the cellulose acylate materials of mixed esters esterified with both acyl and carbamoyl groups. There is no suggestion about influences to film properties, such as optical anisotropy and organic solvent resistance, when the cellulose acylates that are mixed esters esterified with both specific acyl and specific carbamoyl groups are used.

Additionally, combination use of two or more kinds of cellulose acylates (a blend or co-casting thereof) is described in, for example, JP-T-8-510782 (“JP-T” means searched and published International patent application), JP-A-8-231762 (“JP-A” means unexamined published Japanese patent application), JP-A-6-329832, JP-A-2003-41053, JP-A-2000-154278, and JP-A-11-198285. However, films obtained from cellulose acylates that are mixed esters esterified with both specific acyl and carbamoyl groups have not been known until now. Effects on the film properties, such as optical anisotropy and organic solvent resistance, are also not known. JP-A-2001-163995, for example, discloses that specific plasticizers improve optical anisotropy and moisture permeability. These plasticizers are effective for improving optical anisotropy. However, when plasticizers are added in an amount necessary to obtain satisfactory effects, oozing or sublimation of the plasticizers out of a film sometimes occurs, and as such, there is concern about restricted usage.

When the film is used in an optical field of application, for example, used as a member for liquid crystal image display devices, the above-mentioned moisture permeability, glass transition temperature (Tg), optical anisotropy, and organic solvent resistance of the film are problems to be solved, particularly in the points of production and quality management, and in fact, no film has yet satisfied these requirements.

### SUMMARY OF THE INVENTION

The present invention is a cellulose acylate film for optical use, including a cellulose acylate (a), wherein the cellulose acylate (a) is a mixed ester esterified with both acyl and carbamoyl groups, the acyl group is an aliphatic acyl group having 2 to 22 carbon atoms, and the carbamoyl group is an alkyl carbamoyl group having 2 to 24 carbon atoms.

Further, the present invention is a method of producing a cellulose acylate film, including a step of: casting a dope of cellulose acylate dissolved in a solvent, wherein the cellulose acylate used is a cellulose acylate (a) esterified with both acyl and carbamoyl groups, the acyl group is an aliphatic acyl group having 2 to 22 carbon atoms, and the carbamoyl group is an alkyl carbamoyl group having 2 to 24 carbon atoms.

Other and further features and advantages of the invention will appear more fully from the following description.

### DETAILED DESCRIPTION OF THE INVENTION

As a result of eager investigation, the present inventor has found out that a film that contains a cellulose acylate, which is a mixed ester esterified with both specific acyl and specific carbamoyl groups, unexpectedly exhibits favorable properties such as high Tg, small optical anisotropy, and low moisture permeability. Based on this finding, the present invention has been made.

According to the present invention, there are provided the following means:
(1) A cellulose acylate film for optical use that contains a cellulose acylate (a) that is a mixed ester esterified with both acyl and carbamoyl groups, in which the acyl group is an aliphatic acyl group having 2 to 22 carbon atoms, and the carbamoyl group is an alkyl carbamoyl group having 2 to 24 carbon atoms;
(2) The cellulose acylate film for optical use according to the above item (1), wherein the total sum of substitution degrees of hydroxyl groups in the 2-, 3-, and 6-positions of the recurring unit in the cellulose acylate (a) is in the range of from 2.40 to 3.00;
(3) The cellulose acylate film for optical use according to the above item (1) or (2), wherein, in the cellulose acylate (a), a substitution degree of hydroxyl group by the acyl group is in the range of from 1.00 to 2.95, and a substitution degree of hydroxyl group by the carbamoyl group is in the range of from 0.05 to 2.00;
(4) The cellulose acylate film for optical use according to the above item (1), wherein, in the cellulose acylate (a), the acyl group has 2 to 8 carbon atoms and the carbamoyl group has 4 to 22 carbon atoms;
(5) A method of producing the cellulose acylate film for optical use according to any one of the above items (1), (2), (3), and (4);
(6) The cellulose acylate film for optical use according to any one of the above-items (1), (2), (3), and (4), wherein the cellulose acylate film has at least two components selected from the group consisting of the cellulose acylate (a) for optical use according to any one of the above items (1), (2), (3), and (4); a cellulose acylate (b) that is a cellulose acylate esterified with an acyl group having 2 to 12 carbon atoms; and a polymer blend of the cellulose acylate (a) and the cellulose acylate (b); and, the cellulose acylate film has a laminated structure constituted by independent layers of each individual component;
(7) The cellulose acylate film for optical use according to the above item (6), wherein the cellulose acylate (b) is selected from the group consisting of a cellulose acetate, a cellulose acetate propionate, and a cellulose acetate butylate;
(8) The cellulose acylate film for optical use according to the above item (6) or (7), wherein the cellulose acylate (b) is a cellulose acetate;
(9) A method of producing the cellulose acylate film for optical use according to any one of the above items (6), (7), and (8);
(10) An optical film, which includes the cellulose acylate film for optical use according to any one of the above items (1) to (4), or (6) to (8);
(11) A polarizing plate, which includes the cellulose acylate film for optical use according to any one of the above items (1) to (4), or (6) to (8);
(12) An image display device, which includes the cellulose acylate film for optical use according to any one of the above items (1) to (4), or (6) to (8);
(13) A liquid crystal display device, which includes the cellulose acylate film for optical use according to any one of the above items (1) to (4), or (6) to (8);
(14) An organic electroluminescence display device, which includes the cellulose acylate film for optical use according to any one of the above items (1) to (4), or (6) to (8);
(15) A silver halide photosensitive material, which includes the cellulose acylate film for optical use according to any one of the above items (1) to (4), or (6) to (8);
(16) A method of producing a cellulose acylate film, including casting a dope of a cellulose acylate dissolved in a solvent, wherein the cellulose acylate is a cellulose acylate (a) esterified with both acyl and carbamoyl groups, in which the acyl group is an aliphatic acyl group having 2 to 22 carbon atoms, and the carbamoyl group is an alkyl carbamoyl group having 2 to 24 carbon atoms;
(17) The method of producing a cellulose acylate film for optical use according to (16), wherein the cellulose acylate film comprises at least two components selected from the group consisting of the cellulose acylate (a) for optical use according to any one of the above-items (1), (2), (3), and (4); a cellulose acylate (b) esterified with an acyl group having 2 to 12 carbon atoms; and a polymer blend of the cellulose acylate (a) and the cellulose acylate (b); and, the cellulose acylate film is formed by co-casting of 2 to 5 layers;
(18) A method of producing a cellulose acylate film for optical use, that includes the steps of blending the aforementioned cellulose acylate (a) and the cellulose acylate (b), and casting a single layer solution of the blend;
(19) The method of producing a cellulose acylate film according to any one of the above-items (16) to (18), wherein a solvent used consists of a non-chlorinated organic solvent; and
(20) A method of producing a cellulose acylate film, including the steps of melting and extruding a cellulose acylate, wherein the cellulose acylate is the aforementioned cellulose acylate (a), in which the acyl group is an aliphatic acyl group having 2 to 22 carbon atoms and the carbamoyl group is an alkyl carbamoyl group having 2 to 24 carbon atoms.

Each of the glucose units, which constitute cellulose by bonding through β-1,4-glycoside bond, has free hydroxyl groups at the 2-, 3-, and 6-positions thereof. Cellulose acylate for use in the present invention is a polymer obtained by esterifying a part or the whole of these hydroxyl groups with acyl groups and/or carbamoyl groups. In the present specification, a substitution degree means the rate of esterification at the 2-, 3-, or 6-positions in the cellulose, and the total substitution degree means the sum thereof. Specifically, the 100% esterification of any one of the 2-, 3-, and 6-positions is a substitution degree of 1. The 100% esterification of all of the 2-, 3-, and 6-positions gives a total substitution degree of 3, which is the maximum.

The present invention is directed to a cellulose acylate film containing a cellulose acylate that is a mixed ester esterified with both acyl and carbamoyl groups, in which the acyl group is an aliphatic acyl group having 2 to 22 carbon atoms and the carbamoyl group is an aliphatic carbamoyl group having 2 to 24 carbon atoms.

First, the cellulose acylate (a) that is a mixed ester esterified with both acyl and carbamoyl groups for use in the present invention is explained in detail.

In the cellulose acylate (a) that is a mixed ester esterified with both acyl and carbamoyl groups for use in the present invention, an acyl ester is a cellulose derivative (cellulose ester) in which hydrogen atoms of hydroxyl groups of the cellulose are substituted with acyl groups. The acyl group is an aliphatic acyl group having carbon atoms of preferably from 2 to 22, more preferably from 2 to 8, and furthermore preferably from 2 to 4. The substitution degree by the acyl group is preferably in the range of from 1.00 to 2.95, more preferably in the range of from 1.8 to 2.9, and especially preferably in the range of from 2.2 to 2.85. In the cellulose acylate for use in the present invention, the acylate is preferably a chain-like acylate or an alicyclic acylate.

Examples of the acyl group include acetyl, propionyl, butyryl, pentanoyl, hexanoyl, heptanoyl, octanoyl, nonanoyl, decanoyl, undecanoyl, dodecanoyl, tetradecanoyl, hexadecanoyl, octadecanoyl, icosanoyl, cyclohexanoyl, 2-ethylhexanoyl, pivaloyl, t-butylacetyl, 1-adamantanecarbonyl, 1-adamantaneacetyl, 3,5,5-trimethylhexanoyl, 2-adamantanecarbonyl, 4-methylcyclohexanecarbonyl, and 4-pentylcyclohexanecarbonyl.

These groups may have additional substituent(s). However, the substituent is preferably non-polymerizing group. Preferable examples of the substituent include a halogen atom, an alkyl group (including a cycloalkyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an aryl- or heterocyclic-azo group, an imido group, a phosphino group, a phosphinyl group, a phosphinyloxy group, a phosphinylamino group, and a silyl group.

In the cellulose acylate (a) that is a mixed ester esterified with both acyl and carbamoyl groups for use in the present invention, a carbamate is a cellulose derivative in which hydrogen atoms of hydroxyl groups of the cellulose are substituted with carbamoyl groups represented by R—NHCO— (R represents an aliphatic group). The carbamoyl group is an aliphatic carbamoyl group having carbon atoms of preferably from 2 to 24, more preferably from 4 to 22, and especially preferably from 4 to 19. The substitution degree by the carbamoyl group is preferably in the range of from 0.05 to 2.00, more preferably in the range of from 0.1 to 1.2, and especially preferably in the range of from 0.15 to 0.8. In the cellulose acylate for use in the present invention, the carbamate is preferably a chain-like or alicyclic carbamate. If the carbon number of the carbamoyl group is too large, such a problem is caused that mechanical characteristics of the film become small. On the other hand, if the carbon number is too small, sufficient resistance to moisture is hard to be obtained. Further, if the substitution degree by carbamoyl group is too large, it becomes difficult to obtain a film with high transparency. On the other hand, if the substitution degree by carbamoyl group is too small, an elevated Tg and good organic solvent resistance, which are effects of the present invention, are not attained.

These groups may have additional substituent(s). However, the substituent is preferably non-polymerizing group. As examples of preferable substituents, the aforementioned examples of those of the acylate are herein recited.

As to the reason why Tg elevates by substitution of the carbamoyl group, it is assumed that this is a result of improved thermal stability, which is attained under the influence of a hydrogen bond originating from the carbamoyl group.

In the cellulose acylate (a) that is a mixed ester esterified with both acyl and carbamoyl groups for use in the present invention, the total degree of substitution is preferably in the range of from 2.40 to 3.00, more preferably in the range of from 2.6 to 2.97, and especially preferably in the range of from 2.75 to 2.95. If the total substitution degree is too small, humidity resistance of the film is deteriorated.

Specific examples of the cellulose acylate (a) according to the present invention, which is a mixed ester esterified with both acyl group and carbamoyl group, are shown below. However, the present invention is not limited thereto.

TABLE 1

| | Acyl | Substitution | | Substitution |
|---|---|---|---|---|
| Sample | group | degree | Carbamoyl group | degree |
| I-1 | Acetyl | 2.4 | Methylcarbamoyl | 0.4 |
| I-2 | Acetyl | 2.4 | Ethylcarbamoyl | 0.4 |
| I-3 | Acetyl | 2.4 | Propylcarbamoyl | 0.4 |
| I-4 | Acetyl | 2.4 | Isopropylcarbamoyl | 0.4 |
| I-5 | Acetyl | 2.4 | Cyclopropylcarbamoyl | 0.4 |
| I-6 | Acetyl | 2.4 | Butylcarbamoyl | 0.4 |
| I-7 | Acetyl | 2.4 | t-Butylcarbamoyl | 0.2 |
| I-8 | Acetyl | 2.4 | s-Butylcarbamoyl | 0.4 |
| I-9 | Acetyl | 2.4 | i-Butylcarbamoyl | 0.4 |
| I-10 | Acetyl | 2.4 | Pentylcarbamoyl | 0.4 |
| I-11 | Acetyl | 2.4 | Hexylcarbamoyl | 0.4 |
| I-12 | Acetyl | 2.1 | Cyclohexylcarbamoyl | 0.75 |
| I-13 | Acetyl | 2.6 | Heptylcarbamoyl | 0.3 |
| I-14 | Acetyl | 2.4 | Octylcarbamoyl | 0.4 |
| I-15 | Acetyl | 2.4 | Cyclohexylcarbamoyl | 0.4 |
| I-16 | Acetyl | 2.4 | Heptylcarbamoyl | 0.4 |
| I-17 | Acetyl | 2.3 | Octylcarbamoyl | 0.4 |
| I-18 | Acetyl | 2.4 | 2-Ethylhexylcarbamoyl | 0.4 |
| I-19 | Acetyl | 2.4 | Nonylcarbamoyl | 0.4 |
| I-20 | Acetyl | 2.4 | Decylcarbamoyl | 0.4 |
| I-21 | Acetyl | 2.4 | Dodecylcarbamoyl | 0.4 |
| I-22 | Acetyl | 2.4 | Tetradecylcarbamoyl | 0.4 |
| I-23 | Acetyl | 2.4 | Hexadecylcarbamoyl | 0.4 |
| I-24 | Acetyl | 2.4 | Octadecylcarbamoyl | 0.4 |
| I-25 | Acetyl | 2.4 | 1-Adamantylcarbamoyl | 0.2 |
| I-26 | Acetyl | 2.4 | 1,1,3,3-Tetramethylbutylcarbamoyl | 0.2 |
| I-27 | Acetyl | 2.4 | Benzylcarbamoyl | 0.4 |
| I-28 | Acetyl | 2.4 | Butoxycarbonylmethylcarbamoyl | 0.4 |
| I-29 | Acetyl | 2.4 | Ethoxycarbonylmethylcarbamoyl | 0.4 |
| I-30 | Acetyl | 2.4 | 3-Chloropropylcarbamoyl | 0.4 |
| I-31 | Acetyl | 2.2 | Octadecylcarbamoyl | 0.6 |
| I-32 | Acetyl | 2.6 | Octadecylcarbamoyl | 0.24 |
| I-33 | Propionyl | 2.5 | Methylcarbamoyl | 0.35 |
| I-34 | Propionyl | 2.5 | Ethylcarbamoyl | 0.3 |
| I-35 | Propionyl | 2.5 | Propylcarbamoyl | 0.4 |
| I-36 | Propionyl | 2.5 | Isopropylcarbamoyl | 0.4 |
| I-37 | Propionyl | 2.5 | Cyclopropylcarbamoyl | 0.4 |
| I-38 | Propionyl | 2.5 | Butylcarbamoyl | 0.4 |
| I-39 | Propionyl | 2.5 | t-Butylcarbamoyl | 0.2 |
| I-40 | Propionyl | 2.5 | Pentylcarbamoyl | 0.3 |
| I-41 | Propionyl | 2.5 | Hexylcarbamoyl | 0.4 |
| I-42 | Propionyl | 2.5 | Cyclohexylcarbamoyl | 0.3 |
| I-43 | Propionyl | 2.5 | Octylcarbamoyl | 0.4 |
| I-44 | Propionyl | 2.5 | 2-Ethylhexylcarbamoyl | 0.4 |
| I-45 | Propionyl | 2.5 | Decylcarbamoyl | 0.4 |
| I-46 | Propionyl | 2.5 | Dodecylcarbamoyl | 0.35 |
| I-47 | Propionyl | 2.5 | Octadecylcarbamoyl | 0.4 |
| I-48 | Butyryl | 2.5 | Methylcarbamoyl | 0.3 |
| I-49 | Butyryl | 2.4 | Ethylcarbamoyl | 0.4 |
| I-50 | Butyryl | 2.4 | Propylcarbamoyl | 0.4 |
| I-51 | Butyryl | 2.4 | Isopropylcarbamoyl | 0.4 |
| I-52 | Butyryl | 2.4 | Cyclopropylcarbamoyl | 0.4 |
| I-53 | Butyryl | 2.4 | Butylcarbamoyl | 0.4 |
| I-54 | Butyryl | 2.4 | Pentylcarbamoyl | 0.4 |
| I-55 | Butyryl | 2.4 | Hexylcarbamoyl | 0.4 |
| I-56 | Butyryl | 2.4 | Cyclohexylcarbamoyl | 0.4 |
| I-57 | Butyryl | 2.4 | 2-Ethylhexylcarbamoyl | 0.4 |
| I-58 | Butyryl | 2.4 | Octadecylcarbamoyl | 0.45 |
| I-59 | Hexanoyl | 2.5 | Ethylcarbamoyl | 0.4 |
| I-60 | Hexanoyl | 2.5 | Propylcarbamoyl | 0.35 |
| I-61 | Acetyl | 1.75 | Octadecylcarbamoyl | 0.4 |
| I-62 | Acetyl | 0.9 | Octadecylcarbamoyl | 1.8 |
| I-63 | Decanoyl | 2.4 | Octadecylcarbamoyl | 0.35 |
| I-64 | Hexanoyl | 2.4 | Cyclohexylcarbamoyl | 0.4 |
| I-65 | Hexanoyl | 1.2 | Octadecylcarbamoyl | 1.6 |

Next, the cellulose acylate (b) for used in the present invention is described below.

The cellulose acylate (b) is a cellulose acylate having an acyl group of 2 to 12 carbon atoms. Examples of the acyl group include acetyl, propionyl, butyryl, pentanoyl, hexanoyl, heptanoyl, octanoyl, nonanoyl, decanoyl, undecanoyl, dodecanoyl, tetradecanoyl, hexadecanoyl, octadecanoyl, icosanoyl, cyclohexanoyl, 2-ethylhexanoyl, pyvaloyl, t-butylacetyl, 1-adamantanecarbonyl, 1-adamantaneacetyl, 3,5,5-trimethylhexanoyl, 2-adamantanecarbonyl, 4-methylcyclohexanecarbonyl, and 4-pentylcyclohexanecarbonyl. These acyl groups may have additional substituent(s). However, the substituent is neither polymerizing unsaturated hydrocarbon group nor isocyanate group. Preferable examples of the substituent include a halogen atom, an alkyl group (including a cycloalkyl group), an alkynyl group, an aryl group, a heterocyclic group, a cyano group, a hydroxyl group, a nitro group, a carboxyl group, an alkoxy group, an aryloxy group, a silyloxy group, a heterocyclic oxy group, an acyloxy group, a carbamoyloxy group, an alkoxycarbonyloxy group, an aryloxycarbonyloxy group, an amino group (including an anilino group), an acylamino group, an aminocarbonylamino group, an alkoxycarbonylamino group, an aryloxycarbonylamino group, a sulfamoylamino group, an alkyl- or aryl-sulfonylamino group, a mercapto group, an alkylthio group, an arylthio group, a heterocyclic thio group, a sulfamoyl group, a sulfo group, an alkyl- or aryl-sulfinyl group, an alkyl- or aryl-sulfonyl group, an acyl group, an aryloxycarbonyl group, an alkoxycarbonyl group, a carbamoyl group, an arylazo group, a heterocyclicazo group, an imido group, a phosphino group, a phosphinyl group, a phosphinyloxy group, a phosphinylamino group, and a silyl group.

The cellulose acylate (b) is more preferably acetates, propionates, butylates, and a mixed ester of these esters, with acetates being especially preferable.

As to the cellulose acylate (b), the total acyl substitution degree is preferably in the range of from 2.60 to 3.00, more preferably in the range of from 2.7 to 2.97, and especially preferably in the range of from 2.75 to 2.95.

The cellulose acylate film of the present invention does not always need to use the cellulose acylate (b). However, the ratio by mass of (a) to (b) is preferably in the range of from 50:50 to 99.5:0.5, more preferably in the range of from 70:30 to 99:1, and especially preferably in the range of from 80:20 to 98:2. The cellulose acylate film of the present invention may be prepared by blending a cellulose acylate (a) and a cellulose acylate (b) and casting a single layer solution of the blend; or by co-casting solutions of two or more kinds of cellulose acylates selected from the group consisting of (a), (b), and a polymer blend of (a) and (b). The co-casting can be carried out in the manner described in, for example, JP-A-56-162617 and JP-A-2002-316387. When the cellulose acylate film of the present invention is produced by co-casting, the number of layers is preferably from 2 to 5 layers, more preferably from 2 to 4 layers, and especially preferably from 2 to 3 layers.

If the cellulose acylate (a) and the cellulose acylate (b) for use in the present invention are incompatible with each other, they may be mixed by a method of using a solvent that solves each of these two polymers, but in which the two polymers are not mutually soluble, thereby to separate a sea component and an island component from each other. This method or the like makes it possible to prepare a functional film in which a fine dispersion of the island component is homogeneously incorporated.

The cellulose acylate for use in the present invention may be synthesized by any method. As an example of a preferable synthesis method, there can be referred to a method of using cellulose diacetate and isocyanate, as described in M. B. Sabne, Polymer Degradation and Stability, 1986, pp. 47 to 50. An ordinarily skilled person in the art can easily synthesize a cellulose acylate with reference to the aforementioned report and literatures cited therein.

Among the hydroxyl groups of cellulose, the one in the 6-position is a primary alcohol, while those in the 2- and 3-positions are secondary alcohols; and thus there is a difference in reactivity between the substitution positions. Using such difference in reactivity, a position-selective mixed ester synthesis can be conducted. Examples are a method of selectively introducing esters of carboxylic acids or carbamic acids each having a large steric hindrance into the 6-position; a method of selectively introducing a protecting group (for example, t-butyl ether, triphenyl methyl ether) into the 6-position, and then acylating or carbamoylating the other positions, and after releasing the protecting group in the 6-position, introducing another acyl group or carbamoyl group into the hydroxyl group of the 6-position.

The polymerization degree of cellulose acylate (a) for use in the present invention is preferably from 100 to 800, more preferably from 150 to 500, and particularly preferably from 200 to 400. The polymerization degree of cellulose acylate (b) for use in the present invention is preferably from 150 to 800, more preferably from 150 to 500, and particularly preferably from 200 to 400.

The average polymerization degree can be measured by a limiting viscosity method by Uda et al., (Kazuo Uda and Hideo Saito, “Senni-Gakkai Shi (The Journal of the Society of Fiber Science and Technology, Japan)”, vol. 18, No. 1, pp. 105-120, 1962). The viscometric average polymerization degree is described in detail in JP-A-9-95538. The viscometric average polymerization degree can be determined by the use of the intrinsic viscosity [η] of a cellulose acylate measured with an Ostwald's viscometer and the following equation:
DP=[η]/Km (1)
wherein, [η] represents the intrinsic viscosity of the cellulose acylate; Km is a constant of 6×10⁻⁴.

When the viscometric average polymerization degree (DP) is 290 or more, it is preferable that the viscometric average polymerization degree and the concentrated solution viscosity (η) that is measured by a ball-falling type viscometric method satisfy a relationship of the following equation (2):

$$2.814 \times ln ( DP ) - 11.753 ≦ ln ( η ) ≦ 6.29 \times ln ( DP ) - 31.469 \qquad ( 2 )$$

wherein, DP is a value of 290 or more in terms of viscometric average polymerization degree; and η is a passing time (second) between gages according to the ball-falling type viscometric method. The aforementioned equation (2) was calculated from the results obtained by plotting the viscometric average polymerization degree and the concentrated solution viscosity.

Further, with respect to the cellulose derivatives that are difficult to determine a polymerization degree according to the viscometric average polymerization degree, a relative molecular weight according to a GPC method is also able to determine the polymerization degree.

If low molecular weight components are removed from the cellulose acylate, the average molecular weight (polymerization degree) thereof becomes high. However, the viscosity thereof becomes lower than that of ordinary cellulose acylate. Thus, the removal is useful. A cellulose acylate containing low molecular weight components at a small ratio can be obtained by removing low molecular weight components from a cellulose acylate synthesized by an ordinary method. Removal of low molecular weight components can be carried out by washing the cellulose acylate with an appropriate organic solvent. Examples of the organic solvent include ketones (e.g., acetone), acetic esters (e.g., methyl acetate) and cellosolves (e.g., methyl cellosolve). In the present invention, ketones are preferably used, with acetone being particularly preferable.

In order to enhance elimination efficiency of low-molecular components, it is preferable to grind cellulose acylate particles or pass them through a sieve, thereby to control particle size before washing. To produce cellulose acylate containing a reduced amount of low-molecular components, it is preferable that an amount of sulfuric acid catalyst used in the acetylation reaction is regulated to the range of from 5 to 25 parts by mass based on 100 parts by mass of the cellulose acylate. Such regulation of the catalyst amount to the aforementioned range makes it possible to synthesize a cellulose acylate that is also excellent in a molecular weight distribution (namely a molecular weight distribution is uniform).

When the cellulose acylate is used to form the cellulose acylate film of the present invention, the percentage of water content in the cellulose acylate is preferably 2 mass % or less, more preferably 1 mass % or less, even more preferably 0.7 mass % or less. It is known that a conventional cellulose acetate (e.g. cellulose acetate on the market) contains 2.5 to 5 mass % of water. Thus, when a conventional cellulose acetate is used to form the cellulose acylate film of the present invention, it is preferable to dry the cellulose acetate in order to set the percentage of water content to be 2 mass % or less. The drying can be carried out by various known methods.

Various additives (for example, a plasticizer, an ultraviolet absorber, a deterioration inhibitor, fine particles, an optical property controller, and an oil-gelling agent) may be added to the cellulose acylate solution (i.e., the dope) in the present invention in each step in the process for the preparing the solution in accordance with purpose. The addition may be performed at any time of the dope-producing process; and as a final step of the dope-producing process, the step for adding the additives may be added.

To the cellulose acylate films of the present invention, a compound that is called a plasticizer in the conventional cellulose acylate films may be added. The term “plasticizer” herein used is not necessarily a compound to reduce a glass transition temperature (Tg), but may be any of compounds that exhibit various effects such as improvements on water-resisting properties, mechanical properties, optical properties, and processes at the time of film production.

The plasticizer is preferably a liquid having a boiling point at 200° C. or more and is in liquid state at 25° C., or alternatively a solid having a melting point at from 25 to 250° C. More preferably the plasticizer is a liquid having a boiling point at 250° C. or more and is in liquid state at 25° C., or alternatively a solid having a melting point at from 25 to 200° C. Examples of the plasticizer include phosphates and carboxylates.

Examples of the phosphates include triphenyl phosphate (TPP), tricresyl phosphate (TCP), cresyldiphenyl phosphate, octyldiphenyl phosphate, diphenylbiphenyl phosphate, trioctyl phosphate, and tributyl phosphate.

Representative examples of the carboxylates are phthalates and citrates. Examples of the phthalate include dimethyl phthalate (DMP), diethyl phthalate (DEP), dibutyl phthalate (DBP), dioctyl phthalate (DOP), diphenyl phthalate (DPP), and diethylhexyl phthalate (DEHP). Examples of the citrate include triethyl O-acetylcitrate (OACTE), tributyl O-acetylcitrate (OACTB), acetyltriethyl citrate, acetyltrityl citrate, and tri(ethyloxycarbonylmethylene) O-acetylcitrate.

These preferable plasticizers are all liquids at 25° C. except for TPP (melting point about 50° C.). In addition, their boiling point is 250° C. or more.

Other examples of carboxylates include butyl oleate, methylacetyl ricinoleate, dibutyl sebacate, and various trimellitates.

Examples of a glycolic acid ester include triacetin, tributyrin, butylphthalylbutyl glycolate, ethylphthalylethyl glycolate, methylphthalylethyl glycolate, methylphthalylmethyl glycolate, propylphthalylpropyl glycolate, and octylphthalyloctyl glycolate.

Of the plasticizers recited above, triphenyl phosphate, tricresyl phosphate, cresyldiphenyl phosphate, tributyl phosphate, dimethyl phthalate, diethyl phthalate, dibutyl phthalate, dioctyl phthalate, diethylhexyl phthalate, triacetin, and ethylphthalylethyl glycolate are preferred over the others. Further, triphenyl phosphate, diethyl phthalate, and ethylphthalylethyl glycolate are especially preferred.

The plasticizers may be used alone or as a mixture of two or more thereof. The proportion of total plasticizers added is preferably from 2 to 30 mass %, particularly preferably from 5 to 20 mass %, to the cellulose acylate. As the plasticizer to minimize optical anisotropy, various esters such as (di)penta erithritol esters described in JP-A-11-124445, glycerol esters described in JP-A-11-246704, diglycerol esters described in JP-A-2000-63560, citrates described in JP-A-11-92574, and substituted phenyl phosphates described in JP-A-11-90946 are preferably used.

To the cellulose acylate, a deterioration inhibitor (for example, an antioxidant, a peroxide decomposer, a radical inhibitor, a metal deactivator, an acid trapping agent, an amine) and an ultraviolet inhibitor may be added. As to the deterioration inhibitor and ultraviolet inhibitor, they are disclosed in JP-A-60-235852, JP-A-3-199201, JP-A-5-1907073, JP-A-5-194789, JP-A-5-271471, JP-A-6-107854, JP-A-6-118233, JP-A-6-148430, JP-A-7-11056, JP-A-7-11055, JP-A-7-11056, JP-A-8-29619, JP-A-8-239509, JP-A-2000-204173, and JP-A-2000-193821. A preferable adding amount of these is 0.01 to 1 mass %, and more desirably 0.01 to 0.08 mass %, to the solution (dope) to be prepared. When the adding amount is less than 0.01 mass %, effect of the deterioration inhibitor is insufficient, and when the adding amount exceeds 1 mass %, the deterioration inhibitor is possible to bleed out on the film surface.

The deterioration inhibitor is preferably a liquid having a boiling point at 200° C. or more and is in liquid state at 25° C., or alternatively a solid having a melting point at from 25 to 250° C. More preferably the deterioration inhibitor is a liquid having a boiling point at 250° C. or more and is in liquid state at 25° C., or alternatively a solid having a melting point at from 25 to 200° C. When a liquid deterioration inhibitor is used, purification thereof is usually carried out by vacuum distillation. The higher vacuum pressure during the distillation is better. For example, the pressure of 100 Pa or less is preferable.

In addition, purification by means of a molecular distillation apparatus or the like is also preferable. Further, when a solid deterioration inhibitor is used, recrystallization with a solvent, filtration, washing, and drying are generally carried out for purification.

As the deterioration inhibitor, basic compounds of which pKa is 4 or more, that are described in, for example, JP-A-5-194789, are given as preferable examples. For example, primary, secondary, and tertiary amines, and aromatic basic compounds are preferable. More specifically, amines such as tributyl amines, trihexyl amines, trioctyl amines, dodecyl-dibutyl amines, octadecyl-dimethyl amines, tribenzyl amines, and diethylaminobenzenes are enumerated. In more detail, Compounds A-1 to A-73 and B-1 to B-67 described as specific examples of formulae (1) and (2) of the aforementioned publication are commonly listed. As an example of particularly preferable deterioration inhibitor, butylated hydroxy toluene (BHT) is given.

The ultraviolet radiation absorbent preferably used for the cellulose acylate is described below. Examples of the ultraviolet radiation absorbent include an oxybenzophenone-series compound, a benzotriazole-series compound, a salicylate ester-series compound, a benzophenone-series compound, a cyanoacrylate-series compound, and a nickel complex salt-series compound. Specific examples of the ultraviolet radiation absorbents are described below. However, the present invention is not limited thereto.

2-(2′-hydroxy-5′-methylphenyl)benzotriazole, 2-(2′-hydroxy-3′,5′-di-t-butylphenyl)benzotriazole, 2-(2′-hydroxy-3′-t-butyl-5′-methylphenyl)benzotriazole, 2-(2′-hydroxy-3′,5′-di-t-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis(4-(1,1,3,3-tetramethylbutyl)-6-(2H-benzotriazole-2-yl)phenol), 2-(2′-hydroxy-3′-t-butyl-5′-methylphenyl)-5-chlorobenzotriazole, 2,4-dihydroxybenzophenone, 2,2′-dihydroxy-4-methoxybenzophenone, 2-hydroxy-4-methoxy-5-sulfobenzophenone, bis(2-methoxy-4-hydroxy-5-benzoylphenylmethane), (2,4-bis-(n-octylthio)-6-(4-hydroxy-3,5-di-t-butylanilino)-1,3,5-triazine, 2(2′-hydroxy-3′,5′-di-t-butylphenyl)-5-chlorbenzotriazole, (2(2′-hydroxy-3′,5′-di-t-amylphenyl)-5-chlorbenzotriazole, 2,6-di-t-butyl-p-cresol, pentaerythrityl-tetrakis[3-(3,5-di-t-butyl-4-hydroxyphenyl)propionate], triethyleneglycol-bis[3-(3-t-butyl-5-methyl-4-hydroxyphenyl)propionate], 1,6-hexanediol-bis[3-(3,5-di-t-butyl-4-hydroxyphenyl)propionate], 2,4-bis-(n-octylthio)-6-(4-hydroxy-3,5-di-t-butylanilino)-1,3,5-triazine, 2,2-thio-diethylenebis[3-(3,5-di-t-butyl-4-hydroxyphenyl)propionate], octadecyl-3-(3,5-di-t-butyl-4-hydroxyphenyl)propionate, N,N′-haxamethylenebis(3,5-di-t-butyl-4-hydroxy-hydrocinnamide), 1,3,5-trimethyl-2,4,6-tris(3,5-di-t-butyl-4-hydroxybenzyl)benzene, and tris-(3,5-di-t-butyl-4-hydroxybenzyl)-isocyanurate.

Especially, it is more preferable to use (2,4-bis-(n-octylthio)-6-(4-hydroxy-3,5-di-t-butylanilino)-1,3,5-triazine, 2(2′-hydroxy-3′,5′-di-t-butylphenyl)-5-chlorbenzotriazole, (2(2′-hydroxy-3′,5′-di-t-amylphenyl)-5-chlorbenzotriazole, 2,6-di-t-butyl-p-cresol, pentaerythrityl-tetrakis[3-(3,5-di-t-butyl-4-hydroxyphenyl)propionate], and triethyleneglycol-bis[3-(3-t-butyl-5-methyl-4-hydroxyphenyl)propionate].

The ultraviolet ray absorbent may be mixed with a metal inert agents of hydrazine-series compounds like N,N′-bis[3-(3,5-di-t-butyl-4-hydroxyphenyl)propionyl]hydrazine, or with a phosphorus-series processing stabilizer such as tris(2,4-di-tert-butylphenyl)phosphite.

The amount of these compounds to be added is preferably 0.01 to 5 mass %, more preferably 0.05 to 3 mass %, in terms of the proportion by mass to cellulose acylate.

A retardation-rising agent to control optical anisotropy may be added, if necessary. In order to regulate retardation of the cellulose acylate film, an aromatic compound having at least two aromatic rings is preferably used as a retardation-rising agent. Further, when the cellulose acylate film is used as a support for photosensitive materials, a coloring material for preventing light-piping phenomena may be added. The content of a coloring material is preferably from 10 to 1000 ppm, more preferably from 50 to 500 ppm, in terms of the proportion by mass to cellulose acylate. Thus, incorporation of a coloring material can reduce light-piping phenomena of the cellulose acylate film and improve yellow tint. These compounds may be added together with cellulose acylate and a solvent when the cellulose acylate solution is prepared, or alternatively they may be added during or after preparation of the cellulose acylate solution.

If necessary, to the cellulose acylate solution, various additives may be further added in any stage ranging from before to after preparation of the solution. Examples of the additives include inorganic fine particles, heat stabilizing agents such as alkali earth metal salts; antistatic agents, flame retardants, sliding agents, and lubricants. The inorganic fine particles used in this time act as squeak inhibitors and antistatic agents. In this case, a hardness of metal or metal compounds is not particularly restricted, but preferably in the range of from 1 to 10, more from 2 to 10 in terms of Mohs' hardness.

Further, organic fine particles are also preferably used. Examples of the organic fine particles include cross-linked polystyrenes, cross-linked polymethylmethacrylates, and cross-linked triazine resins. Particularly, in the present invention, fine particles are generally added to a cellulose acylate film in order to prevent scratching and worsening of the transportation property when the cellulose acylate film is handled.

Preferable examples of these matt agents are specifically enumerated below. As the inorganic compounds, silicon-containing compounds, silicon dioxide, titanium oxide, zinc oxide, aluminum oxide, barium oxide, zirconium oxide, strontium oxide, antimony oxide, tin oxide, tin antimony oxide, calcium carbonate, talc, clay, calcined kaoline, calcined calcium silicate, hydrated calcium silicate, aluminum silicate, magnesium silicate, and calcium phosphate, and the like, are preferable. Among these compounds, silicon-containing inorganic compounds and zirconium oxides are more preferable. For example, articles on the market that are sold by the trade names such as Aerosil R972, R974, R812, 200, 300, R202, OX50, TT600 (trade names, those manufactured by Nippon Aerosil Co., Ltd.) may be used. As the fine particles of zirconium oxide, for example, articles on the market that are sold by the trade names such as Aerosil R976 and R811 (trade names, those manufactured by Nippon Aerosil Co., Ltd.) may be used.

As the organic compounds, for example, polymers such as silicone resin, fluororesin, and acrylic resin are preferably used. Among these polymers, silicone resin is more preferably used. Of the silicone resin, those having a three-dimensional netlike structure are particularly preferable. For example, articles on the market that are sold by the trade names such as Tospearl 103, Tospearl 105, Tospearl 108, Tospearl 120, Tospearl 145, Tospearl 3120 and Tospearl 240 (trade names, those manufactured by Toshiba Silicone Co., Ltd.) may be used.

In view of minimizing haze, the primary average size of these fine particles is preferably in the range of from 0.001 to 20 μm, more preferably in the range of from 0.001 to 10 μm, furthermore preferably in the range of from 0.002 to 1 μm, and especially preferably in the range of from 0.005 to 0.5 μm. In measurement of the primary average size of fine particles, the particle size can be measured in terms of average particle size by means of a transmission electron microscope. Apparent specific gravity of fine particles is preferably at least 70 g/L, more preferably in the range of from 90 to 200 g/L, and especially preferably in the range of from 100 to 200 g/L.

To the cellulose acylate solution for use in the present invention, an oil-gelling agent may be added, and this is effective to improve casting characteristics and surface state of the formed film. The raw materials of the oil-gelling agents are not particularly restricted, so long as they are able to cause gelation of a cellulose acylate solution when added to the solution. The term “gelation” used in present specification means a state that a solution of cellulose acylate dissolved in an organic solvent has lost its fluidity or has solidified, by adding oil-gelling agents to the solution on account of mutual reaction of the oil-gelling agents or interactions between the oil-gelling agents and the cellulose acylate, and moreover, interactions between the oil-gelling agents and the organic solvent or the like. Namely, as the oil-gelling agents for use in the present invention, any compounds may be used, so long as they can self-associate and form a gelling structure in an organic solvent for cellulose acylate, using as a driving force secondary interactions that are not a covalent bond, such as a hydrogen bond, electrostatic interactions, coordination bond, van der waals force, and π-π electron interactions.

As these oil-gelling agents, there can be used those described in known literatures (for example, J. Chem. Soc. Japan, Ind. Chem. Soc., 46, 779 (1943), J. Am. Chem. Soc., 111, 5542 (1989), J. Chem. Soc. Chem. Commun., 1993, 390, Angew. Chem. Int. Ed. Engl., 35, 1949 (1996), Chem. Lett., 1996, 885, J. Chem. Soc. Chem. Commun., 1997, 545).

Further, those described in the followings can be applied to the present invention: for example, Kobunshi Ronbunshu (Japanese Journal of Polymer Science and Technology), Vol. 55, No. 10, pp. 585 to 589 (October, 1998), Hyoumen (The surface), Vol. 36, No. 6, pp. 291 to 303 (1998), Sen-i To Kogyo (Journal of Society of Fiber Science and Technology, Japan), Vol. 56, No. 11, pp. 329 to 332 (2000), JP-A-7-247473, JP-A-7-247474, JP-A-7-247475, JP-A-7-300578, JP-A-10-265761, JP-A-7-208446, JP-A-5-230435, JP-A-5-320617, and JP-A-2000-3003.

Preferable oil-gelling agents are selected from 1,2,3,4-dibenzylidene-D-sorbitol, 12-hydroxystearic acid, amino acid derivatives (for example, N-lauroyl-L-glutamic acid-α), cyclic dipeptides (2,5-diketopiperazine derivatives), γ-bis-n-butylamides, spin-labeled steroids, cholesterol derivatives, phenol cyclic oligomers, 2,3-bis-n-hexadecyloxy anthracenes, butyrolactone derivatives, urea derivatives, vitamin H derivatives, gluconamide derivatives, cholic acid derivatives, mixtures of barbituric acid derivatives and triamino pyrimidine derivatives, cyclohexanediamine derivatives, and cyclohexanetricarboxylic acid derivatives. They may be used solely or in a mixture of two or more of these compounds. Further, it is also preferable that the oil-gelling agents are cyclic dipeptides obtained from compounds selected from the group consisting of valine, leucine, isoleucine, aspartic acid, aspartic acid esters, glutamic acid, glutamic acid esters, and phenylalanine. Further, it is also preferable that the oil-gelling agents are α-aminolactam derivatives.

The content of the oil-gelling agent is preferably in the range of from 0.01 to 5% by mass, more preferably in the range of from 0.02 to 4% by mass, and especially preferably in the range of from 0.02 to 3% by mass, of the cellulose acylate solution.

Next, an organic solvent to be used in the preparation of the solution of cellulose acylate will be described. In the present invention, the organic solvent is not particularly limited as far as the cellulose acylate can be dissolved, cast, and made into a film. The organic solvent may be a chlorinated organic solvent or a non-chlorinated organic solvent. As preferable examples of the chlorinated organic solvent, dichloromethane and chloroform can be mentioned. Dichloromethane is particularly preferable. Turning to preferable examples of the non-chlorinated organic solvents, they may be a single solvent, or a mixed solvent, with the mixed solvent being preferable. The non-chlorinated organic solvents are described in detail below.

An organic solvent which is for use as a main solvent is preferably selected from an ester having 3 to 12 carbon atoms, a ketone having 3 to 12 carbon atoms, and an ether having 3 to 12 carbon atoms. The ester, the ketone, or the ether may have a cyclic structure. A compound having two or more functional groups of ester, ketone, or ether (that is, —O—, —CO—, or —COO—) is also usable as a main solvent. The solvent may have other functional group such as alcoholic hydroxyl group. If the main solvent is a compound having two or more kinds of functional groups, the number of carbon atoms of the solvent is within the limitation for a compound having either of the functional groups.

Examples of the ester having 3 to 12 carbon atoms include ethyl formate, propyl formate, pentyl formate, methyl acetate, ethyl acetate, and pentyl acetate. Examples of the ketone having 3 to 12 carbon atoms include acetone, methylethyl ketone, diethyl ketone, diisobutyl ketone, cyclopentanone, cyclohexanone, and methylcyclohexane. Examples of the ether having 3 to 12 carbon atoms include diisopropyl ether, dimethoxymethane, dimethoxyethane, 1,4-dioxane, 1,3-dioxolane, tetrahydrofuran, anisole, and phenetole. Examples of the compound having two or more kinds of functional groups include 2-ethoxyethyl acetate, 2-methoxyethanol, and 2-butoxyethanol.

As to the aforementioned main solvents of the cellulose acylates for use in the present invention, preferable ones can be shown in terms of solubility parameter. Namely, for the cellulose acylates for use in the present invention, their solubility parameters range from 17 to 22 MPa^{1/2}. There are many publications describing about the solubility parameter. The detail is described in, for example, the literature authored by J. Brandrup, E. H et al.: Polymer Handbook (fourth edition), VII/671 to VII/714. Among them, the organic solvents that can be effectively used for the cellulose acylates for use in the present invention preferably have solubility parameter ranging from 19 to 21 MPa^{1/2}.

Examples of the organic solvents having the solubility parameter of from 19 to 21 MPa^{1/2} include methylethylketone (19), cyclohexanone (20.3), cyclopentanone (20.9), methyl acetate (19.6), 2-butoxyethanol (19.4), methylene chloride (20.3), dioxane (19.6), 1,3-dioxolane (19.8), acetone (20.3), ethyl formate (19.2), methyl acetoacetate (about 20), and tetrahydrofuran (19.4). Of these, solvents such as methyl acetate, acetone, methyl acetoacetate, cyclopentanone, cyclohexanone, and methylene chloride are most preferable. These are described in JP-A-9-95538. Further, N-methylpyrolidone described in JP-A-61-124470, fluoroalcohol described in JP-A-11-60807, and 1,3-dimethyl-2-imidazolidinone described in JP-A-2000-63534 may also be used.

The solvent used for the cellulose acylate is selected from the various viewpoints as mentioned above, but is preferably a mixed solvent composed of three or more kinds of solvents different from each other.

The first solvent is one selected from the following or a mixed solvent composed of two or more selected from the following: methyl acetate, ethyl acetate, methyl formate, ethyl formate, acetone, dioxolane, and dioxane. The first solvent is preferably methyl acetate, acetone, methyl formate, or ethyl formate, or a mixture thereof.

The second solvent is one selected from the following or a mixed liquid composed of two or more selected from the following: ketones having 4 to 7 carbon atoms, and acetoacetic acid esters. The second solvent is preferably methyl ethyl ketone, cyclopentanone, cyclohexanone, or methyl acetylacetate, or a mixed liquid thereof.

When the first solvent is a mixed liquid composed of two or more solvents, none of the second solvent may be used.

The third solvent is selected from alcohols or hydrocarbons having 1 to 10 carbon atoms, preferably alcohols having 1 to 8 carbon atoms.

In the alcohol as the third solvent, the portion other than hydroxyl group may be in a straight, branched, or cyclic form. In particular, the third solvent is preferably an alcohol derived from a saturated aliphatic hydrocarbon. The alcohol may be any one of primary, secondary, and tertiary alcohols. Examples of the alcohol as the third solvent include methanol, ethanol, 1-propanol, 2-propanol, 1-butanol, 2-butanol, t-butanol, 1-pentanol, 2-methyl-2-butanol, and cyclohexanol.

The alcohol may be a fluorinated alcohol. Examples thereof include 2-fluoroethanol, 2,2,2-trifluoroethanol, and 2,2,3,3-tetrafluoro-1-propanol.

The hydrocarbon as the third solvent may be in a straight, branched, or cyclic form. The hydrocarbon may be an aromatic hydrocarbon or an aliphatic hydrocarbon. The aliphatic hydrocarbon may be saturated or unsaturated. Examples of the hydrocarbon include cyclohexane, hexane, benzene, toluene, and xylene.

The alcohols and the hydrocarbons as the third solvents may be used alone or in the form of a mixture of two or more thereof; there is no particular limitation on this. As the third solvent, specific examples of the preferred compound include, as alcohols: methanol, ethanol, 1-propanol, 2-propanol, 1-butanol, 2-butanol, and cyclohexanol; and as hydrocarbons: cyclohexane, and hexane. Among these, methanol, ethanol, 1-propanol, 2-propanol, and 1-butanol are more preferable.

About the mixed solvent composed of the first, second, and third solvents, the first solvent, the second solvent, and the third solvent are contained preferably at proportions of 20 to 90% by mass, 5 to 60% by mass, and 5 to 30% by mass, respectively; more preferably at proportions of 30 to 86% by mass, 10 to 50% by mass, and 7 to 25% by mass, respectively, with the third solvent being an alcohol; even more preferably at proportions of 30 to 80% by mass, 10 to 50% by mass, and 10 to 20% by mass, respectively, with the third solvent being an alcohol.

When the first solvent is a mixed liquid and the second solvent is not used at all, the first solvent and the third solvent are contained preferably at proportions of 20 to 90% by mass and 5 to 30% by mass, respectively; more preferably at proportions of 30 to 86% by mass and 7 to 25% by mass, respectively. Preferable examples of the combination of the solvents in the present invention are described below. However, the combination is not limited to these examples.
Methyl acetate/acetone/methanol/ethanol/butanol (75/10/5/5/5, mass parts),
Methyl acetate/acetone/methanol/ethanol/propanol (75/10/5/5/5, mass parts),
Methyl acetate/acetone/methanol/ethanol/cyclohexane (75/10/5/5/5, mass parts),
Methyl acetate/methyl ethyl ketone/methanol/ethanol (80/10/5/5, mass parts),
Methyl acetate/acetone/methyl ethyl ketone/ethanol (75/10/10/5, mass parts),
Methyl acetate/cyclopentanone/methanol/ethanol (80/10/5/5, mass parts),
Methyl acetate/cyclopentanone/acetone/methanol/ethanol (60/15/15/5/5, mass parts),
Methyl acetate/cyclohexanone/methanol/hexane (70/20/5/5, mass parts),
Methyl acetate/methyl ethyl ketone/acetone/methanol/ethanol (50/20/20/5/5, mass parts),
Methyl acetate/1,3-dioxolane/methanol/ethanol (70/20/5/5, mass parts),
Methyl acetate/dioxane/acetone/methanol/ethanol (60/20/10/5/5, mass parts),
Methyl acetate/acetone/cyclopentanone/ethanol/butanol/cyclohexane (65/10/10/5/5/5, mass parts),
Methyl formate/methyl ethyl ketone/acetone/methanol/ethanol (50/20/20/5/5, mass parts),
Methyl formate/acetone/ethyl acetate/ethanol/butanol/hexane (65/10/10/5/5/5, mass parts),
Acetone/methyl acetoacetate/methanol/ethanol (65/20/10/5, mass parts),
Acetone/cyclopentanone/ethanol/butanol (65/20/10/5, mass parts),
Acetone/1,3-dioxolane/ethanol/butanol (65/20/10/5, mass parts),
1,3-Dioxolane/cyclohexanone/methyl ethyl ketone/methanol/butanol (60/20/10/5/5, mass parts)
Acetone/methylene chloride/methanol (85/5/5, mass parts),
Methyl acetate/methylene chloride/methanol/ethanol (70/10/15/5, mass parts),
1,3-Dioxolane/methylene chloride/methanol/butanol (70/15/10/5, mass parts),
1,4-Dioxane/methylene chloride/acetone/methanol/butanol (70/5/15/5/5, mass parts),
Cyclohexanone/methylene chloride/acetone/methanol/ethanol/propanol (60/10/15/5/5/5, mass parts),
Methyl acetate/acetone/methanol/ethanol (75/15/5/5, mass parts), and
Acetone/methyl acetoacetate/ethanol/isopropanol (65/20/10/5, mass parts).

Among these, more preferable examples of the combination of the solvents in the present invention are followings:
Methyl acetate/acetone/methanol/ethanol (75/15/5/5, mass parts),
Methyl acetate/acetone/methanol/ethanol/butanol (75/10/5/5/5, mass parts),
Methyl acetate/cyclopentanone/methanol/ethanol (80/10/5/5, mass parts), and
Acetone/methyl acetoacetate/ethanol/isopropanol (65/20/10/5, mass parts).

In the preparation of a cellulose acylate solution (dope), there is no particular restriction on dissolution method. Namely, the dope may be prepared at room temperature, or by a chilling dissolving method or a high-temperature dissolving method, or a combination of these methods. Methods of preparing the cellulose acylate solution are described in, for example, JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-4-259511, JP-A-2000-273184, JP-A-11-323017, and JP-A-11-302388. The above-described methods of dissolving a cellulose acylate in an organic solvent can be properly applied to the present invention as long as they do not exceed the scope of the present invention.

Dissolution of the cellulose acylate in a non-chlorinated organic solvent that is practiced in the present invention is specifically described in more detail below.

In the case of room-temperature dissolution, the cellulose acylate is mixed with a solvent and additives at a temperature of 0 to 55° C., and stirred and mixed to dissolve, in a still or other dissolving machine. In the dissolution, it is important to soak cellulose acylate powders thoroughly and uniformly in a solvent. In other words, it is essential not to generate so-called “an undissolved lump of flour” (a part of cellulose acylate powder which is not permeated by solvent at all). Therefore, it is sometimes preferred to previously add a solvent into an agitation vessel, and then to add cellulose acylate to a dissolution vessel under a reduced pressure.

In contrast with that, it is sometimes preferable that cellulose acylate is previously added to an agitation vessel, and thereafter a solvent is added to a dissolution vessel under a reduced pressure. Further, a preferable preparation method of the solution is a method in which cellulose acylate is previously wetted with a poor solvent such as an alcohol, followed by addition of an ether, ketone, or ester solvent having 3 to 12 carbon atoms. When two or more solvents are used, their addition order is not particularly restricted. For example, cellulose acylate may be added to a main solvent, followed by addition of other solvent(s) (for example, a gelling solvent such as alcohol), or conversely, cellulose acylate may be previously wetted with a gelling solvent, followed by addition of a main solvent. These methods effectuate prevention of dissolution with non-uniformity. The agitation may be carried out in such a way that after mixing cellulose acylate and a solvent, the mixture is left to stand to thoroughly swell the cellulose acylate with the solvent, and is subsequently agitated to make a homogeneous solution.

A preparation of a cellulose acylate solution (dope) that is preferably used in the present invention is carried out according to a chilling dissolving method that is explained below.

First, a cellulose acylate is gradually added with stirring to an organic solvent at a temperature around room temperature (−10 to 55° C.). When two or more solvents are used, their addition order is not particularly restricted. For example, cellulose acylate may be added to a main solvent, followed by addition of other solvent(s) (for example, a gelling solvent such as alcohol), or conversely, cellulose acylate may be previously wetted with a gelling solvent, followed by addition of a main solvent. These methods effectuate prevention of dissolution with non-uniformity. It is preferable to regulate a content of the cellulose acylate so as to become within the range of 5 to 40% by mass. of the mixture. The content of the cellulose acylate is more preferably in the range of 10 to 30% by mass of the mixture. Further, arbitrary additives, which will be described later, may be previously added to the mixture.

Next, the mixture is cooled to a temperature ranging from −100 to −10° C., preferably from −100 to −30° C., more preferably from −100 to −50° C., especially preferably from −90 to −60° C. The cooling may be practiced with a refrigerant such as a dry ice-methanol bath and a mechanically cooled fluorinated solvent (flon). Upon such cooling, the mixture of cellulose acylate and a solvent is solidified. The cooling rate is not particularly restricted. However, in a batch cooling system, the viscosity of a cellulose acylate solution increases with the progress of cooling, and thereby the cooling efficiency declines. Therefore, it is necessary to use a still that is efficient to reach a required temperature.

Alternatively, the cooling of cellulose acylate can be carried out by transferring a cellulose acylate solution, for a short period of time, in a cooling machine that is set at a prescribed temperature, after swelling the cellulose acylate. It is preferable to increase the cooling speed as much as possible, but the theoretical upper limit thereof is 10,000° C./sec. The technical upper limit is 1,000° C./sec, and the practical upper limit is 100° C./sec. The cooling rate is a value obtained by dividing the difference between the initial temperature and the final temperature after cooling, by the period of time from the beginning of cooling up to the time the final cooling temperature attained. Further, upon warming to a temperature of from 0 to 200° C., preferably from 0 to 150° C., more preferably from 0 to 120° C., and especially preferably from 0 to 50° C., the solidified mixture turns to a solution in which cellulose acylate flows in an organic solvent. To elevate temperature, the solidified mixture may be left just under the condition of room temperature, or alternatively it may be warmed in a warm bath. It is pointed out that pressure at this time becomes from 0.3 to 30 MPa. However, there is no problem in particular. In this case, it is preferable to heat in a short period of time as quickly as possible. Heating is more preferably done in a short period of time of from 0.5 to 60 minutes, and particularly preferably from 0.5 to 2 minutes.

If dissolution is insufficient, operations of cooling and warming may be repeated in turn. Whether the dissolution is complete or not can be determined simply by observing appearance of the solution with the naked eye. In the chilling dissolving method, use of a closed vessel is preferred to prevent inclusion of moisture that is caused owing to dew formation at the time of cooling. In the operations of cooling and warming, pressurization at the time of cooling and decompression at the time of warming may shorten the dissolution time. In order to practice pressurization or decompression, use of a pressure-resistant vessel is advisable. Details of the aforementioned chilling dissolving method are described in JP-A-9-95544 and JP-A-10-95854.

Next, the high-temperature dissolving method that is preferably practiced in the preparation of a cellulose acylate solution (dope) is explained below.

First, a cellulose acylate is gradually added with stirring to an organic solvent at a temperature around room temperature (−10 to 55° C.). When two or more solvents are used, their addition order is not particularly restricted. For example, cellulose acylate may be added to a main solvent, followed by addition of other solvent(s) (for example, a gelling solvent such as alcohol), or conversely, cellulose acylate may be previously wetted with a gelling solvent, followed by addition of a main solvent. These methods effectuate prevention of dissolution with non-uniformity. In the preparation of a cellulose acylate solution, it is preferable that the cellulose acylate is added to a mixed organic solvent containing various solvents and previously swelled with the mixed organic solvent. In this case, the cellulose acylate may be gradually added with stirring to any one solvent at a temperature of from −10 to 55° C. According to occasions, the cellulose acylate may be previously swelled with a particular solvent, followed by adding and mixing with other solvent(s) to be used in combination, to make a uniform swelling solution. Alternatively, the cellulose acylate may be previously swelled with two or more kinds of particular solvents, followed by addition of the remainder of solvents. Thus, the addition methods and orders are not particularly restricted.

Then, the organic solvent mixture solution is heated under pressurization of from 0.2 MPa to 30 MPa at a temperature of from 60 to 240° C., more preferably from 80 to 220° C., furthermore preferably from 100 to 200° C., and especially preferably from 100 to 190° C. For heating, for example, high-pressure steam or electric heat sources may be used. For pressurization, pressure-resistant vessels or pressure lines are needed. The materials of these vessels or lines are not particularly restricted, but a steel, a stainless steel, or other metals may be used. Further, carbon dioxide may be encapsulated in these high-pressure and high-temperature solutions, to prepare a so-called supercritical solution. In this case, the ratio by mass of carbon dioxide to a solvent is preferably in the range of from 5/95 to 70/30, and more preferably in the range of from 10/90 to 60/40.

Because it is difficult to coat these heated solutions as they are, the solutions need to be cooled below the lowest boiling point of the used solvents. Generally in this case, by cooling to a temperature ranging from −10 to 55° C., the solutions are returned to an ordinary pressure. The cooling may be accomplished in such a manner that a high-pressure and high-temperature vessel or line containing a cellulose acylate solution is just left at room temperature. More preferably these devices may be cooled with a refrigerant such as cooling water. In order to accelerate dissolution, operations of heating and cooling may be repeated in turn. Whether the dissolution is complete or not can be determined simply by observing appearance of the solution with the naked eye. In the high-pressure and high-temperature dissolving method, use of a closed vessel is preferred to prevent evaporation of solvent(s). In the swelling process, pressurization and/or decompression may shorten the dissolving time. In order to practice pressurization or decompression, use of a pressure-resistant vessel or line is essential. Details of these methods are described in JP-A-11-322946 and JP-A-11-322947.

The amount of cellulose acylate is adjusted so that the cellulose acylate can be contained in a solution preferably in the range of from 5 to 40% by mass, and more preferably in the range of from 10 to 30% by mass. The present invention is characterized in a high concentration of the cellulose acylate solution as mentioned above. Without recourse to a means of concentration, a cellulose acylate solution having a high concentration and excellent stability can be obtained according to the present invention. In order to make dissolution further easier, it is also effective that dissolution is initiated at a low density and then the solution is concentrated by means of concentration. Concentration may be carried out by a concentrating method such as a method of obtaining a concentrated solution with evaporation of a solvent that comprises the steps of introducing a low concentration solution to the space between a cylinder and the rotating locus formed by the outer periphery of a blade rotating in the peripheral direction inside the cylinder, and applying a difference in temperature between the cylinder and the solution, as described in JP-A-4-259511; and a method of recovering a concentrated solution that comprises the steps of blowing a heated low-concentration solution from a nozzle to a chamber, conducting flash evaporation of the solvent in the period of time until the solution from the nozzle strikes upon an inner wall of the chamber, and at the same time removing solvent vapor from the chamber, as described in U.S. Pat. Nos. 2,541,012, 2,858,229, 4,414,341 and 4,504,355.

In advance to casting, it is preferable to eliminate from the solution, unsolved materials and foreign materials such as dust and impurities, by filtration with an appropriate filtering medium such as metal gauze (wire mesh) or flannel. For filtration of the cellulose acylate solution, it is preferable to use a filter having absolute filtration accuracy of from 0.1 to 100 μm, and more preferably a filter having absolute filtration accuracy of from 0.5 to 25 μm. The filter thickness is preferably in the range of from 0.1 to 10 mm, and more preferably in the range of from 0.2 to 2 mm. In this case, the pressure applied for filtration is preferably 16 kgf/cm² (1.57 MPa) or less, more preferably 12 kgf/cm² (1.18 MPa) or less, furthermore preferably 10 kgf/cm² (0.98 MPa) or less, and particularly preferably 2 kgf/cm² (0.20 MPa) or less. As the filtering medium, conventionally known materials such as glass fibers, cellulose fibers, filter papers, fluoroplastics (e.g., tetra-fluorinated ethylene resins) are preferably used. Particularly, ceramics and metals are preferably used. The viscosity of the cellulose acylate solution just before the film production is not particularly restricted, so long as the viscosity is within the range in which casting can be completed at the time of film formation. Generally, the cellulose acylate solution is prepared so as to have a viscosity of preferably from 10 Pa.s to 2,000 Pa.s, more preferably from 30 Pa.s to 1,000 Pa.s, and furthermore preferably from 40 Pa.s to 500 Pa.s. The temperature at this time is not particularly restricted, as far as the temperature is identical to the casting temperature; however, the temperature is preferably in the range of from −5 to 70° C., and more preferably in the range of from −5 to 55° C.

Next, the producing method of the film using the cellulose acylate solution is described below. The method and apparatus for producing the cellulose acylate film of the present invention may be a solution-casting film-forming method and a solution-casting film-forming apparatus that are supplied to produce conventional cellulose triacetate films. A dope (a cellulose acylate solution) prepared in a dissolving device (pot) is once stored in a storing pot. The dope is subjected to antifoaming treatment to prepare a final dope. From a discharging port in the pot, the dope is fed through a metering pump (for example, a pressurizing-type constant-flow-rate gear pump capable of feeding a constant flow rate of liquid with high precision by controlling the number of rotations of the gear) to a pressurizing-type die. The dope is homogeneously cast from a mouthpiece (slit) of the pressurizing-type die onto a metal support at a casting section that is running endlessly. Thereafter, the dope film that is half-dried, which is referred to as a “web” also, is peeled from the metal support at a peeling point which is after a substantial one circumference from the dope-casting point. Both ends of the thus-obtained web were fastened with a clip. Then, the web is dried while a width of the web is held and the web is transported with a tenter. Continuously the web is transported with rolls in a drying machine, to complete drying. A prescribed length of the dried web is wound using a reeling (winding) machine. A combination of a tenter and a drying machine installed with rolls may vary depending upon the end use of a web. In the solution-casting film production method that is used to produce silver halide photosensitive materials and functional protective films for electronic display, not only a solution-casting film producing apparatus but also a coating machine is often added for surface treatment of the film, to provide layers such as a subbing layer, an antistatic layer, an antihalation layer, and a protective layer. Production processes are each described in brief below. However, the present invention is not limited to these processes.

At the time of forming a cellulose acylate film by the solution film-producing method, a prepared cellulose acylate solution (dope) is cast over a drum or a band, and then the solvent is removed therefrom by vaporization, thereby forming a film. The solid-component concentration of the dope before casting is preferably adjusted to the range of 5 to 40 mass %. The drum or band surface is preferably subjected in advance to a mirror-smooth finish. The dope used is preferably cast onto a drum or band having a surface temperature of 30° C. or less. A metal support temperature of from −10 to 20° C. is particularly preferable. To the present invention, there can be further applied technologies described in JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511, and JP-A-2-208650.

In the present invention, the obtained cellulose acylate solution may be cast as a single layer onto a smooth band or drum that acts as a metal support. Alternatively, plural (two or more) cellulose acylates or cellulose acylate solutions may be cast on the aforementioned band or drum. A method of producing a film by casting plural (two or more) cellulose acylates or cellulose acylate solutions is referred to as “co-casting” in the present specification.

When casting two or more cellulose acylates or cellulose acylate solutions, the cellulose acylates or the cellulose acylate solutions may be formed into a film while they are cast successively from their respective casting dies disposed at intervals in the direction of progress of the metal support and laminated one by one on top of the other. For example, the methods disclosed in JP-A-61-158414, JP-A-1-122419, and JP-A-11-198285 can be adopted. The film formation by casting cellulose acylates or cellulose acylate solutions from two casting dies may be employed, and this can be conducted by the methods disclosed in JP-B-60-27562 (“JP-B” means examined Japanese patent publication), JP-A-61-94724, JP-A-61-947245, JP-A-61-104813, JP-A-61-158413, and JP-A-6-134933. In addition, the casting method disclosed in JP-A-56-162617 is favorably adopted, wherein the flow of a high-viscosity cellulose acylate solution is enveloped in a low-viscosity cellulose acylate solution and both of the high and low-viscosity cellulose acylate solutions are extruded simultaneously.

A method of incorporating a higher quantity of an alcohol component, which is a poor solvent, in the outer side solution than that in the inner side solution, as described in JP-A-61-94724 and JP-A-61-94725, is also a preferable embodiment. Alternatively, films may be produced by a method of using two casting dies (cast openings), which comprises the steps of peeling a film formed on a metal support from the first casting die, and then conducting the second casting using the second casting die on the side of the film contacted with the metal support surface. This method is described in, for example, JP-B-44-20235. The cellulose acylate solutions to be caste may be the same or different, and they are not restricted. So that the plural cellulose acylate solution layers can exhibit different functions from each other, cellulose acylate solutions corresponding to the respective functions may be extruded from different casting dies respectively. The cellulose acylate solution for use in the present invention may be cast simultaneously together with other functional layers (for example, an adhesive layer, a dye layer, an antistatic layer, an antihalation layer, a UV absorbing layer, a polarizing layer).

Referring to a conventionally known single layer solution, extrusion of a cellulose acylate solution with a high concentration and high viscosity was necessary to obtain a desired film thickness. In this case, often caused were problems such as inferior flatness, and spot troubles due to solid substances generated because of poor stability of the cellulose acylate solution. A measure to solve these problems is to cast two or more cellulose acylate solutions from casting dies. By this method, high viscosity solutions can be extruded at the same time on a metal support, and a film with a good flatness and an excellent face quality can be prepared. In addition, a drying load can be reduced by use of a concentrated cellulose acylate solution, so that a production speed of the film can be enhanced.

In the case of co-casting, the thickness of the inside layer and the outside layer is not particularly restricted. The thickness of the outside layer is preferably in the range of from 1 to 50%, more preferably in the range of from 2 to 30%, of the entire film thickness. In the case of co-casting at least three layers, the sum total of the film thickness of the layer in contact with a metal support and of the layer in contact with air is defined as the film thickness of the outside. In the case of co-casting, a laminated structure cellulose derivative film can be prepared by co-casting cellulose derivative solutions with different densities of additives, such as the aforementioned plasticizer, UV absorbing agent, and matting agent. For example, a cellulose derivative film having a constitution of skin layer/core layer/skin layer, or the like, can be prepared. For example, a matting agent may be added to a skin layer in an amount higher than a core layer, or exclusively to the skin layer. In contrast, a plasticizer and a UV absorbing agent may be added to a core layer in an amount higher than a skin layer, or exclusively to the core layer. The kinds of plasticizers and UV absorbing agents may be changed between a core layer and a skin layer. For example, it is possible that a low volatile plasticizer and/or UV absorbing agent is added to a skin layer and a plasticizer excellent in plasticity or a UV absorbing agent excellent in UV absorption is added to a core layer. Further, it is also a preferable embodiment that a stripping agent is added exclusively to the skin layer on the side of a metal support. For gelation of a solution by cooling in the chill-drum method, it is also preferable that alcohol as a poor solvent is added to a skin layer in an amount higher than a core layer. Tg may be different between a skin layer and a core layer. Tg of the core layer is preferably lower than that of the skin layer. Further, the viscosity of a solution containing cellulose derivatives at the time of casting may be different between a skin layer and a core layer. Viscosity of the skin layer is preferably lower than that of the core layer; but viscosity of the core layer may be lower than that of the skin layer.

A casting method that is useful in the present invention is further described in detail below.

As the casting method, there are, for example, a method of uniformly extruding a prepared dope from a pressure die onto a metal support, a doctor blade method in which the film thickness of a dope once cast on a metal support is controlled with a blade, and a reverse roll coater method in which the film thickness is controlled with back-rotating rolls. Of these methods, the aforementioned method of using a pressure die is preferable. Examples of the pressure die include those of coat-hanger type and T-die type, with these types being preferably used. In addition to the aforementioned methods, various conventionally known film production methods of casting a cellulose acylate solution may be applied to the present invention. If working conditions are set in each method considering difference between solvents used, such as boiling points, the same effects as described in each publication can be obtained. As an endlessly running-metal support that is used to produce the cellulose acylate film of the present invention, a mirror finished drum with a chrome-plating surface or a stainless belt (or band) mirror-finished by polishing its surface may be used. As the pressure die that is used to produce a cellulose acylate film of the present invention, one or at least two dies may be arranged above the metal support. Arrangement of one or two dies is preferable. When two or more dies are installed, the casting amount of a dope may be divided into these dies with various proportions. Alternatively, dopes may be transferred to the dies, from plural precision quantitative gear pumps with respective proportions. The temperature of the cellulose acylate solution used for casting is preferably in the range of from −10 to 55° C., more preferably in the range of from 25 to 50° C. In this case, the temperature may be fixed during all steps, or may be different in each step. In the latter case, the temperature should be controlled so as to become a prescribed temperature just before casting.

As the method of drying a dope on a metal support that is used for producing a cellulose acylate film of the present invention, generally there are a method of blowing hot air from the surface side of a metal support (drum or belt), namely from the surface side of a web on the metal support; a method of blowing a hot air from the back side of a drum or belt; and a liquid heat-transfer method in which a temperature-controlled liquid is contacted with the back side of a drum or belt that is opposite to the dope-casting side and the drum or belt is heated by the action of heat transfer, thereby the surface temperature being controlled. Of these methods, the liquid heat-transfer method (heat transmission from the back side) is preferable. The surface temperature of a metal support before casting is not particularly restricted, so long as the temperature is below the boiling point of a solvent used for the dope. However, in order to accelerate drying or to reduce flowability of the dope on the metal support, it is preferred to set the temperature lower by the range of from 1 to 10° C. than the lowest boiling point of the solvents used. The above is not applied to the case where, after cooling, the cast dope is peeled without drying.

In addition, a method of positively stretching a film in the width direction may also be used, as described, for example, in JP-A-62-115035, JP-A-4-152125, JP-A-4-284211, JP-A-4-298310, and JP-A-11-48271. This is a method of stretching the produced cellulose acylate film thereby to increase a value of in-plane retardation of the film. Stretching of the film is carried out under the condition of room temperature or elevated temperature. The elevated temperature is preferably below the glass transition temperature of the film. The stretching of the film may be uniaxial or a biaxial. The stretching is preferably in the range of from 1 to 200%, and especially preferably in the range of from 1 to 100%. The thickness of the finished (dried) cellulose acylate film of the present invention varies depending on end use, but generally it is in the range of from 5 to 500 μm, preferably in the range of from 20 to 300 μm, and most preferably in the range of from 30 to 150 μm. The film thickness may be controlled, by regulating a solid content of the dope, an interval between head slits of the die, an extrusion pressure from the die, a transportation rate of the metal support and so on, so as to obtain a desired thickness.

The width of the cellulose acylate film thus obtained is preferably in the range of from 0.5 to 3 m, more preferably in the range of from 0.6 to 2.5 m, and furthermore preferably in the range of from 0.8 to 2.2 m. The length of the film wound is preferably in the range of from 100 to 10,000 m, more preferably in the range of from 500 to 7,000 m, and furthermore preferably in the range of from 1,000 to 6,000 m per roll respectively. At the time of winding, knurling is preferably given to at least one end (edge) of the film. The width of knurling is preferably in the range of from 3 to 50 mm, more preferably in the range of from 5 to 30 mm; and the height of knurling is preferably in the range of from 0.5 to 500 μm, and preferably in the range of from 1 to 200 μm. Such knurling may be a one-sided press or a two-sided press.

The cellulose acylate film may be subjected to a surface treatment, if necessary, in order to achieve strong adhesion between the cellulose acylate film and each functional layers (e.g., subbing layer and backing layer). As the above-mentioned surface treatment, various surface-activation treatments can be used, such as a glow discharge treatment, an ultraviolet ray treatment, a corona discharge treatment, a flame treatment, an acid treatment, and an alkali treatment. The glow discharge treatment referred to herein means a treatment with so-called low-temperature plasma, generated in a low-pressure gas having a pressure of 10⁻³ to 20 Torr (0.1 Pa to 2.7 kPa). Treatment with plasma under atmospheric pressure is also preferable. The plasma treatment that is used for a surface treatment of the cellulose acylate film of the present invention is explained below. Specifically, there are treatments using vacuum glow discharge, atmospheric pressure glow discharge, and the like. In addition, there are other methods such as a flame plasma treatment. As these methods, those described in, for example, JP-A-6-123062, JP-A-11-293011, and JP-A-11-5857 may be used. Particularly the treatment using atmospheric pressure glow discharge is preferably used. The term “plasma-exciting gas” means a gas to be excited by plasma under the aforementioned conditions. Examples of the gas include argon, helium, neon, krypton, xenon, nitrogen, carbon dioxide, flons such as tetrafluoro methane, and a mixture thereof.

As to these gases, a mixture obtained by adding an inactive gas such as argon and neon with a reactive gas capable of giving to the surface of a plastic film a polar functional group such as a carboxyl group, a hydroxyl group, or a carbonyl group, is used as an exciting gas. As the reactive gas, there can be used not only hydrogen, oxygen and nitrogen, but also gases such as water vapor and ammonia, and if necessary, low-boiling point organic compounds such as lower hydrocarbons and ketones may also be used. However, in view of handling, gases such as hydrogen, oxygen, carbon dioxide, nitrogen, and water vapor are preferable. In the case of using water vapor, a gas obtained by passing and bubbling another gas through water may be used. Alternatively water vapor may be mixed with another gas.

Ultraviolet irradiation treatment may also be preferably used in the present invention. For example, treatments described in JP-B-43-2603, JP-B-43-2604, and JP-B-45-3828 are preferably used. As the mercury vapor lamp, preferred is a high-pressure mercury vapor lamp composed of a silica tube, emitting ultraviolet rays having a wavelength of from 180 to 380 nm. In a method of irradiating ultraviolet rays, a high-pressure mercury vapor lamp having a main wavelength of 365 nm may be used as a light source, unless no troubles of the support performance arise even though the surface temperature of the cellulose acylate film increases up to about 150° C. When a low-temperature treatment is needed, a low-pressure mercury vapor lamp having a main wavelength of 254 nm is preferable. Further, high-pressure mercury vapor lamps and low-pressure mercury vapor lamps of the ozone-less type may also be used. The more the amount of light irradiated for treatment is, the more the adhesive force between the cellulose acylate film and a layer adhered thereto improves. However, increase of the light amount causes such problems that the film is colored and also becomes frangible. Consequently, in the case of a high-pressure mercury vapor lamp having a main wavelength of 365 nm, an amount of light irradiated is preferably in the range of from 20 to 10,000 (mJ/cm²), and more preferably in the range of from 50 to 2,000 (mJ/cm²). In the case of a low-pressure mercury vapor lamp having a main wavelength of 254 nm, an amount of light irradiated is preferably in the range of from 100 to 10,000 (mJ/cm²), and more preferably in the range of from 300 to 1,500 (mJ/cm²).

As the surface treatment of the cellulose acylate film, a corona discharge treatment is also preferably used. For example, the treatment can be practiced by the methods described in JP-B-39-12838, JP-A-47-19824, JP-A-48-28067, and JP-A-52-42114. As the corona discharge processor, for example, a solid-state corona treater made by Pillar Co., a LEPEL type surface treater, and a VETAPHON type treater can be used. The treatment may be practiced in air under an ordinary pressure.

The flame treatment is described below. As the kind of gases used, any of a natural gas, a liquefied propane gas, and a town gas may be used. However, a mixing ratio of the gas and air is important. The reason is because it is considered that effects of the surface treatment owing to a flame treatment are obtained by the action of plasma containing active oxygen. The points are activity (temperature) of plasma and the amount of available oxygen, which are important characteristics of flame. A determinant of these two characteristics is a ratio of gas/oxygen. In a proper reaction of these components, energy density becomes the maximum, and activities of plasma are enhanced. Specifically, the preferable mixing ratio by volume of natural gas/air is in the range of ⅙ to 1/10, and more preferably in the range of 1/7 to 1/9. The mixing ratio by volume of liquefied propane gas/air is preferably in the range of 1/14 to 1/22, and more preferably in the range of 1/16 to 1/19. The mixing ratio by volume of town gas/air is preferably in the range of ½ to ⅛, and more preferably in the range of ⅓ to 1/7. The amount of the flame treatment is preferably in the range of 1 to 50 kcal/m², and more preferably in the range of 3 to 20 kcal/m².

An alkali saponification treatment that is preferably used as a surface treatment of the cellulose acylate film is explained in detail below. The alkali saponification treatment is preferably practiced by a cyclic system of dipping a cellulose acylate film surface in an alkaline solution, neutralizing with an acidic solution, washing, and drying. Examples of the alkaline solution include a potassium hydroxide solution and a sodium hydroxide solution. The normal density of hydroxide ion is preferably in the range of 0.1N to 3.0N, and more preferably in the range of 0.5N to 2.0N. The temperature of the alkaline solution is preferably in the range of room temperature to 90° C., and more preferably in the range of 40 to 70° C. Subsequently, the film is generally washed, and thereafter passed through an acidic solution, followed by washing, to obtain a surface-treated cellulose acylate film. Examples of acids for use in the acidic solution in this treatment include hydrochloric acid, nitric acid, sulfuric acid, acetic acid, formic acid, chloroacetic acid, and oxalic acid. The concentration of the acidic solution is preferably in the range of 0.01N to 3.0N, and more preferably in the range of 0.05N to 2.0N.

When the cellulose acylate film of the present invention is used as a transparent protective film of a polarizing plate, it is particularly preferable to practice an acid treatment or alkaline treatment, namely a saponification treatment to the cellulose acylate film, in view of adhesiveness to a polarizing film. The solution used for these treatments may be water alone or a mixture of water and a water-soluble organic solvent (for example, methanol, ethanol, isopropanol, acetone).

In order to adhere a functional layer on the film, there are a method in which after conducting a surface activation treatment, a functional layer is coated directly on the activated surface of the cellulose acylate film so that an adhesive force can be obtained; and a method in which once the film is subjected to arbitrary surface treatment, or omitting such surface treatment, an undercoating layer (adhesive layer) is provided on the film and a functional layer is coated on the undercoating layer. As to the constitution of the undercoating layer, there are several techniques. One of them is a so-called multilayer method in which a layer (hereinafter referred to as a first undercoating layer) well adhesive to the support is provided as a first layer, and a second undercoating layer well adhesive to a functional layer is coated as a second layer on the first undercoating layer.

In a single layer method, an excellent adhesiveness can be attained by a method of swelling a cellulose acylate film, followed by interface mixing of the swollen cellulose acylate film with materials of an undercoating layer. As the undercoating polymer for use in the present invention, water-soluble polymers, cellulose acylates, latex polymers, and water-soluble polyesters are exemplified. Examples of the polymers include gelatin, gelatin derivatives, casein, agar-agar, sodium alginate, starch, polyvinyl alcohol, polyacrylic acid copolymers, and maleic anhydride copolymers. Examples of the cellulose derivatives include carboxymethyl cellulose and hydroxyethyl cellulose.

The cellulose acylate films of the present invention are applied to optical articles and photosensitive materials. Particularly it is preferred that the optical article is a liquid crystal display device. Further, it is more preferable that the liquid crystal display device has a configuration wherein a liquid crystal cell carrying a liquid crystal between two sheets of electrode substrates, two sheets of polarizers disposed at both sides of the liquid crystal cell, and at least one optical compensating sheet disposed between the liquid crystal cell and the polarizer. As these liquid crystal display devices, TN, IPS, FLC, AFLC, OCB, STN, VA, and HAN are preferable. The detail of these devices is described later. When the cellulose acylate film prepared by using a non-chlorinated organic solvent in accordance with the present invention is used for the aforementioned optical articles, various kinds of functional layers may be applied on the film. Examples of the functional layers include an antistatic layer, a hardening resin layer (transparent hard coat layer), an anti-reflection layer, an enhanced-adhesion layer, an anti-glare layer, an optical compensating layer, an orientating layer, and a liquid crystal layer. As materials of the functional layers that are preferably used in the present invention, surface-active agents, sliding agents, and matting agents are enumerated.

The surface-active agents are mainly classified into dispersing agents, coating agents, wetting agents, and anti-static agents, depending on their purposes for use. These purposes can be attained by properly using surface-active agents described below. As the surface-active agents, any of nonionic or ionic (anionic, cationic, or betaine) ones may be used. Further, fluorinated surface-active agents are also preferably used as coating agents or anti-static agents in an organic solvent. As to the layer in which surface-active agents are used, these surface-active agents may be used in a cellulose acylate solution, or in any other functional layers. In the case of using the film in optical articles, examples of the functional layers include an undercoating layer, an interlayer, an orientation-controlling layer, a refractive-index controlling layer, a protective layer, a stain-proofing layer, an adhesive layer, a back subbing layer, and a back layer. The amount of a surface-active agent to be used is not particularly restricted, so far as it is an amount necessary to attain the purpose of using the surface-active agent. Generally, the amount is preferably in the range of from 0.0001 to 5% by mass, more preferably in the range of from 0.0005 to 2% by mass, based on mass of the layer to which the surface-active agent is added. In this case, the coating amount is preferably in the range of from 0.02 to 1000 mg, more preferably in the range of from 0.05 to 200 mg, per m².

Examples of preferred nonionic surface-active agent include the surface active agents of which the nonionic hydrophilic group is polyoxyethylene, polyoxypropylene, polyoxybutylene, polyglycidyl or sorbitan; and specific examples include polyoxyethylene alkyl ether, polyoxyethylene alkyl phenyl ether, polyoxyethylene-polyoxy propylene glycol, polyalcohol fatty acid partial ester, polyoxyethylene polyalcohol fatty acid partial ester, polyoxyethylene fatty acid ester, polyglycerin fatty acid ester, a fatty acid diethanolamide, and triethanolamine fatty acid partial ester.

The anionic surface-active agent is preferably a carboxylate, a sulfate, a sulfonic acid salt, or a phosphate salt; and typical examples are fatty acid salts, alkyl benzene sulfonic acid salts, alkyl naphthalene sulfonic acid salts, alkyl sulfonic acid salts, α-olefin sulfonic acid salts, dialkylsulfosuccinic acid salts, α-sulfonated fatty acid salts, N-methyl-N-oleyl taurines, petroleum sulfonic acid salts, alkyl sulfate salts, sulfated fats and oils, polyoxyethylene alkylether sulfates, polyoxyethylene alkyl phenyl ethereal sulfate salts, polyoxyethylene styrenated phenyl ether sulfate salts, alkyl phosphate salts, polyoxyethylene alkylether phosphates, naphthalene sulfonic acid salt formaldehyde condensates, and the like.

The cationic surface-active agent is preferably an ammonium salt, a quaternary ammonium salt, a pyridium salt, or the like; and examples are primary, secondary, or tertiary fatty ammonium salts, and quaternary ammonium salts (tetraalkylammonium salts, trialkyl benzyl ammonium salts, alkyl pyridium salts, alkyl imidazolium salts, and the like).

The amphoteric surface-active agent is preferably a carboxy betaine, a sulfobetaine, or the like; and examples include N-trialkyl-N-carboxymethyl ammonium betaines, and N-trialkyl-N-sulfoalkylene ammonium betaines.

These surface-active agents are described in Takao Karigome, Kaimen Kassezai no Oyo (Application of Surface-active agents), (Saiwai Shobo, Sep. 1, 1980). In the present invention, the amount of preferable surface-active agents is not particularly restricted, so far as the amount is enough to obtain aimed properties of the surface-active agent. As specific examples of preferable compounds, there are enumerated compounds WA-1 to S-6 described on page 34 of Japan Institute of Invention and Innovation (JIII) Kokai-Giho No. 2001-1745.

A sliding agent may be contained in any layer of the cellulose acylate film. In this case, as the layer, the outermost layer is particularly preferable. As the usable sliding agent, there are known, for example, polyorganosiloxanes as disclosed in JP-B-53-292, higher fatty acid amides as disclosed in U.S. Pat. No. 4,275,146, higher fatty acid esters (esters of fatty acids having 10 to 24 carbon atoms and alcohols having 10 to 24 carbon atoms) as disclosed in JP-B-58-33541, British Patent No. 927,446, JP-A-55-126238, and JP-A-58-90633; metal salts of higher fatty acids as disclosed in U.S. Pat. No. 3,933,516, and esters of straight chain higher fatty acids and straight chain higher alcohols and esters of higher alcohols and higher fatty acids including a branched-chain alkyl group, as disclosed in JP-A-58-50534.

Among these compounds, as the polyorganosiloxanes, use can be made of not only generally known polyalkylsiloxanes such as polydimethylsiloxane and polydiethylsiloxane, and polyarylsiloxanes such as polydiphenylsiloxane and polymethylphenylsiloxane, but also modified polysiloxanes such as organopolysiloxanes having an alkyl group of 5 or more carbon atoms, alkylpolysiloxanes having a polyoxyalkylene group at a side chain, and organopolysiloxanes having, at a side chain, an alkoxy group, a hydroxyl group, a hydrogen atom, a carboxyl group, an amino group, or a mercapto group; as disclosed in JP-B-53-292, JP-B-55-49294, and JP-A-60-140341. In addition, block copolymers having a siloxane unit are also enumerated. As specific examples of preferable compounds, there are enumerated compounds S-1 to WA-24 described on pages 33 to 34 of Japan Institute of Invention and Innovation (JIII) Kokai-Giho No. 2001-1745.

As the higher fatty acids and derivatives thereof and the higher alcohols and derivatives thereof, there can be used higher fatty acids, metal salts thereof, higher fatty acid esters, higher fatty acid amides, polyhydric alcohol esters of higher fatty acids, and the like, and higher aliphatic alcohols, monoalkylphosphites of higher aliphatic alcohols, dialkylphosphites of higher aliphatic alcohols, trialkylphosphites of higher aliphatic alcohols, monoalkylphosphates of higher aliphatic alcohols, dialkylphosphates of higher aliphatic alcohols, trialkylphosphates of higher aliphatic alcohols, higher aliphatic alkyl sulfonic acids, their amide compounds, and their salts. As specific examples of preferable compounds, there are enumerated compounds S-7 to S-15 described on page 34 of Japan Institute of Invention and Innovation (JIII) Kokai-Giho No. 2001-1745.

The use of these sliding agents enables to obtain films excellent in scratch resistance and free from troubles such as generation of cissing at the undercoating layer side of the surface. The amount of the sliding agent is not particularly restricted, but the content is preferably in the range of from 0.0005 to 2 g/m², more preferably in the range of from 0.001 to 1 g/m², particularly preferably in the range of from 0.002 to 0.5 g/m². The layer to which the sliding agent is added is not particularly restricted, but the outermost layer of the back face (side) is preferable. The aforementioned surface layer containing the sliding agent may be formed by a method of coating a coating solution of the sliding agent dissolved in a proper organic solvent, on a support or a support provided thereon a backing layer and other layers, followed by drying. Alternatively, the sliding agent may be added to a coating solution in the form of dispersion. The sliding performance in terms of coefficient of static friction is preferably 0.30 or less, more preferably 0.25 or less, and particularly preferably 0.13 or less. It is preferred to minimize coefficient of static friction between the sliding agent and materials of the layer contacting therewith. This helps to prevent the film from scratching and the like. The coefficient of static friction between the sliding agent and materials of the layer contacting therewith is also preferably 0.30 or less, more preferably 0.25 or less, particularly preferably 0.13 or less. Further, in many cases, it is also preferable to minimize coefficient of static friction between both sides (surface and back) of a film or an optical film. In this case, the coefficient of static friction between both sides is also preferably 0.3 or less, more preferably 0.25 or less, and particularly preferably 0.13 or less. Further, the coefficient of kinetic friction is also preferably 0.30 or less, more preferably 0.25 or less, and particularly preferably 0.13 or less. Further, the coefficient of kinetic friction between the sliding agent and materials of the layer contacting therewith is also preferably 0.3 or less, more preferably 0.25 or less, particularly preferably 0.15 or less. Further, in many cases, it is also preferable to minimize coefficient of kinetic friction between both sides (surface and back) of a film or an optical film. The coefficient of kinetic friction between both sides is also preferably 0.30 or less, more preferably 0.25 or less, particularly preferably 0.13 or less.

In functional layer(s) of the cellulose acylate film of the present invention, a matt agent is preferably used in order to improve a slipping property of the film and adhesion resistance under high humidity. In this case, an average height of projections at the surface is preferably in the range of from 0.005 to 10 μm, and more preferably in the range of from 0.01 to 5 μm. It is preferred that the number of the projections at the surface is as many as possible. However, an excessively large number of the projections will cause a problem such as haze. As far as projections are within the average height thereof, the content of the projections, in the case where the projections are formed with, for example, spherical or irregular shaped matt agents, is preferably in the range of from 0.5 to 600 mg/m², and more preferably in the range of from 1 to 400 mg/m². As the matt agent used, the aforementioned fine particles that can be added to a cellulose acylate film can also be used. The composition of the matt agent is not particularly restricted, and it may be an inorganic material, or an organic material, or a mixture of two or more kinds of materials. As the inorganic compounds and organic compounds that are used for a matt agent, there can be mentioned, for example, a fine powder of inorganic materials such as barium sulfate, manganese colloid, titanium dioxide, barium strontium sulfate, silicon dioxide, aluminum oxide, tin oxide, zinc oxide, calcium carbonate, barium sulfate, talc, kaolin, and calcium sulfate. In addition, silicon dioxide such as synthetic silica obtained by a wet method or gelation of silica, and titanium dioxide (rutile-type and anatase-type ones) produced by titanium slag and sulfuric acid, and so on, are also enumerated.

The matt agent may be obtained by grinding inorganic materials having a relatively large grain size of, for example, 20 μm or more, followed by classification (vibrating screen, air classification). In addition, there is enumerated a grinding fraction of organic high molecular compounds such as polytetrafluoroethylene, cellulose acetate, polystyrene, polymethyl methacrylate, polypropylmetacrylate, polymethylacrylate, polyethylene carbonate, acrylstyrene-series resins, silicone-series resins, polycarbonate resins, benzoguanamine-series resins, melamine-series resins, polyolefin-series resins, polyester-series resins, polyamide-series resins, polyimide-series resins, polyfluoroethylene-series resins, and starch. Further, high molecular compounds synthesized by suspension polymerization, and high molecular compounds or inorganic compounds that are rounded in shape by a spray-dry process or a dispersion method may be used.

The optical film of the present invention may be used, for example, as a protective film for a polarizing plate. To the polarizing plate, treatments such as antistatic processing, transparent hard coat processing, anti-glare processing, anti-reflection processing, and enhanced adhesion processing may be applied. Alternatively, the optical film of the present invention may be formed with an orientation film, and then it is applied to a liquid crystal layer, so that an optical compensation function can be given. The detail of these technologies that can be applied is described in JP-A-2000-352620. These are described below. The antistatic processing is a technology to give a function of preventing a resin film from electrification that generates at the time of handling of the resin film. Specifically, this processing may be carried out by providing a layer containing ionic conductive materials or conductive fine particles. The ionic conductive materials herein used mean materials that exhibit electrical conductivity and contain ions that are a carrier to transport electricity. As the ionic conductive materials, ionic high molecular compounds are exemplified. Of these compounds, conductive materials that are of fine particles and added, as a fine dispersion, to the aforementioned resins are preferred. As a preferable conductive material, conductive fine particles composed of metal oxides or composite oxides of these metal oxides, and ionene conductive polymers and quaternary ammonium cationic conductive polymer particles having an intermolecular cross-link as described in JP-A-9-203810 are enumerated. The particle size is preferably in the range of 5 nm to 10 μm. The more preferable range of the particle size varies depending on the kind of fine particles.

As the metal oxides that are conductive fine particles, for example, ZnO, TiO₂, SnO₂, Al₂O₃, In₂O₃, SiO₂, MgO, BaO, MoO₂, V₂O₅, or composite oxides of these metals are preferable. Particularly ZnO, TiO₂, and SnO₂ are preferable. As examples of the metal oxides containing foreign atoms, addition of Al, In or the like to ZnO; addition of Nb, Ta or the like to TiO₂; and addition of Sb, Nb, a halogen element or the like to SnO₂ are effective. The amount of the foreign atoms added is preferably in the range of from 0.01 to 25 mol %, and particularly preferably in the range of from 0.1 to 15 mol %. Further, electron conductive organic compounds may also be used. Examples of the compounds include polythiophene, polypyrrole, polyaniline, polyacetylene, and polyphosphazene. They are preferably used in the form of a complex with an acid-providing material such as polystyrene sulfonic acid or perchloric acid.

In the optical film of the present invention, a transparent hard coat layer may be disposed. As the transparent hard coat layer, active radiation hardening resins and heat hardening resins are preferably used. The active radiation hardening resin layer means a layer that contains, as a main component, a resin capable of hardening upon reactions such as a cross-linking reaction by irradiation of active radiation such as ultraviolet rays and electron rays. As the active radiation hardening resins, ultraviolet radiation hardening resins and electron radiation hardening resins are enumerated as typical examples. In addition, other resins capable of hardening by irradiation of active radiation except for ultraviolet rays and electron rays may also be used. Examples of the ultraviolet radiation hardening resins include ultraviolet ray hardening type acrylurethane resins, ultraviolet ray hardening type polyester acrylate resins, ultraviolet ray hardening type epoxyacrylate resins, ultraviolet ray hardening type polyolacrylate resins, and ultraviolet ray hardening type epoxy resins. Generally, the ultraviolet ray hardening type acrylurethane resins are readily obtained by a method of reacting a polyesterpolyol with an isocyanate monomer or a prepolymer, and then reacting the reaction product with an acrylate-series monomer having a hydroxyl group, such as 2-hydroxyethylacrylate, 2-hydroxyethyl methacrylate (hereinafter the term “acrylate” is defined to include methacrylate, and reference to “acrylate” will be used to mean not only acrylate but also methacrylate). Such synthesis method is described in, for example, JP-A-59-151110.

In the optical film of the present invention, an antireflection layer may be disposed. As a structure of the antireflection layer, various kinds of structures such as a single layer structure and a multilayer structure are known. As the multilayer structure, generally known is a structure where high refractive index layers and low refractive index layers are alternately laminated. As specific examples of the structure, there are illustrated a two-layered laminate of high refractive index layer/low refractive index layer in the order from a transparent substrate side, and a three-different refractive index layered laminate of middle refractive index layer (a layer whose refractive index is higher than that of a transparent substrate or a hard coat layer, but lower than that of a high refractive index layer)/high refractive index layer/low refractive index layer in this order. In addition to these, various laminates with more numerous antireflection layers are also proposed. Of these laminates, a structure formed by coating high refractive index layer/middle refractive index layer/low refractive index layer on a substrate having thereon a hard coat layer is preferable from the viewpoints such as durability, optical properties, cost, and productivity. Particularly preferred antireflection layer is an antireflection laminate prepared by applying, on a substrate, a middle refractive index layer (optional), a high refractive index layer, and a low refractive index layer, toward open air in this order, with controlling optical film thickness of the high refractive index layer and the low refractive index layer to a definite value to the wavelength of light, to form an interference layer. Both refractive index and film thickness can be calculated by a method of measuring a spectral reflectance.

To the optical film of the present invention, anti-curling processing may be applied. The anti-curling processing is to give a function of curling toward the processed surface. When some surface processing is applied to one side of a transparent resin and resulted in both sides of the resin were different in the applied degrees and kinds of surface processing, the anti-curling processing enables to prevent the film from curling toward one surface. As the disposition of anti-curling layers, there are illustrated an embodiment of applying the anti-curling layer to the side of a substrate opposite to the side to which the anti-glare layer or anti-reflection layer is applied; and an embodiment of coating the anti-curling layer to the side of a transparent resin film opposite to another side of the resin film where, for example, an enhanced adhesion layer is coated.

The in-plane retardation of the film (Re) can be measured by using ellipsometer (AEP-100 (trade name), produced by Shimazu Corporation). The in-plane retardation (retardation in the surface) is a value determined by multiplying the difference between the longitudinal refractive index and the lateral refractive index at the wavelength of 632.8 nm by the value of film thickness, and the value can be obtained according to the following formula:
Re=(nx−ny)×d
wherein nx represents the refractive index of the slow phase axis direction (the direction at which the refractive index is maximum); ny represents the refractive index of the direction orthogonal to the slow phase axis; and d represents the film thickness (nm). The in-plane retardation (Re) of a cellulose ester film is preferably 50 nm or less, more preferably 40 nm or less, further preferably 30 nm or less, and most preferably 20 nm or less.

The retardation in the thickness (perpendicular) direction of film (Rth) is a value determined by multiplying the birefringence index in thickness direction measured at the wavelength of 632.8 nm by the value of film thickness, and this value can be obtained according to the following formula:
Rth={(nx+ny)/2−nz}×d
wherein nx represents the refractive index of the slow phase axis direction (the direction at which the refractive index is maximum); ny represents the refraction index of the direction orthogonal to the slow phase axis; nz represents the refractive index of the thickness direction; and d represents the film thickness (nm). The preferable retardation (Rth) in the thickness direction of a cellulose ester film varies depending on use of the film. When the film is used as a protective film for polarizing plate, which is particularly suitable use for the film of the present invention, the Rth value is preferably 80 nm or less, more preferably 50 nm or less, furthermore preferably 40 nm or less, and most preferably 30 nm or less. The birefringence index {(nx+ny)/2−nz} in the thickness direction is preferably 0.0005 or less, more preferably 0.0002 or less, and most preferably 0.0001 or less.

In the present invention, the longitudinal (lengthwise) and horizontal dimensional shrinkage percent is preferably ±0.1% or less, respectively, when the cellulose acylate film produced as described above is left under conditions of 105° C. for 5 hours. The value of haze converted into that of 80 μm of the cellulose acylate film, is preferably 0.6% or less, more preferably 0.5% or less, and furthermore preferably 0.1% or less. The lower limit of haze value is not particularly restricted. The tear strength of the optical film of the present invention is preferably 10 g or greater, more preferably 12 g or greater, furthermore preferably 15 g or greater, and still moreover preferably 18 g or greater, furthermore preferably 20 g or greater, and still furthermore preferably 22 g or greater. The tensile strength of the cellulose acylate film is preferably 50 N/mm² or more. Further, the modulus of elasticity is preferably 3 kN/mm² or more. The kinetic coefficient of friction of the cellulose acylate film is preferably 0.40 or less, and more preferably 0.35 or less. The optical film of the present invention is excellent in dimensional stability. Specifically, the dimensional shrinkage percent of the film having been subjected to standing for 12 hours under the conditions of 80° C./90%RH is preferably less than ±0.5%, more preferably less than ±0.3%, furthermore preferably less than ±0.1%, still more preferably less than ±0.08%, still furthermore preferably less than ±0.06%, and most preferably less than “0.04%.

First, an outline of applications of the cellulose acylate film produced according to the present invention is roughly described. The details are described later. The cellulose acylate films of the present invention for optical use are preferably used for polarizing plates, polarizing-plate protective films, phase difference films, and view-angle enlarging films, each of which is used for liquid crystal image display devices; front surface filters for plasma displays; front surface filters for organic EL panels; supports for liquid crystal display elements; supports for polarizing plates; supports for photosensitive materials; and so on. Where the film is used as a polarizing plate-protective film, the production method of polarizing plates is not particularly restricted, but they may be produced by an ordinary method. For example, there is a method of producing a polarizing plate, comprising the steps of alkali-treating the obtained cellulose acylate film, and sticking, with using an aqueous solution of completely saponificated polyvinyl alcohol, the alkali-treated films onto both sides of a polarizer produced by dipping a polyvinyl alcohol film in an iodine solution, followed by stretching. In place of the alkali treatment, an enhanced adhesion processing as described in JP-A-6-94915 and JP-A-6-118232 may be adopted to the aforementioned production method. As examples of the adhesive that is used to adhere the treated side of the protective film and the polarizer, polyvinyl alcohol-series adhesives such as polyvinyl alcohol and polyvinyl butyral, and vinyl-series latexes such as butyl acrylate are enumerated.

A polarizing plate is generally composed of a polarizer and protecting films to protect both surfaces of the polarizer, and the thus-prepared polarizing plate is further provided with a protect film stuck to one surface of the polarizing plate, and a separation film stuck to the opposite surface of the polarizing plate. The protect film and the separation film are used in order to protect the polarizing plates when the polarizing plates are shipped and subjected to a product testing or the like. In this case, the protect film is stuck in order to protect the surface of a polarizing plate and the film is used at the side of the surface opposite to the surface with which the polarizing plate is stuck to a liquid crystal plate. On the other hand, the separation film is used to cover an adhesive layer to stick to the liquid crystal plate and the film is used at the same side as the surface with which the polarizing plate is stuck to a liquid crystal plate. In liquid crystal display devices, usually, a substrate containing liquid crystals is disposed between two polarizing plates. A polarizing-plate protective film to which the optical film of the present invention is applied can exhibit excellent display performances, regardless of the site the film disposed. Particularly, because a transparent hard coat layer, an anti-glare layer, an anti-reflection layer, and the like layers are disposed to a polarizing-plate protective film to be disposed at the outermost surface of a liquid crystal display devices, employment of the aforementioned polarizing-plate protective film of the present invention at this site is especially preferable.

The cellulose acylate film of the present invention can be utilized for various purposes. It is especially effective when the cellulose acylate film is used as an optical compensation sheet for liquid crystal display device. When the cellulose acylate film itself is used as an optical compensation sheet, the transmission axis of a polarizing element (described later) and the slow phase axis of an optical compensation sheet composed of the cellulose acylate film can be arranged at any angle. A liquid crystal display device has a constitution of a liquid crystal cell carrying liquid crystal between two pieces of electrode substrate, two polarizing elements disposed on both surfaces of the liquid crystal cell, and at least one optical compensation sheet disposed between the liquid crystal cell and the polarizing element. The liquid crystal layer of the liquid crystal cell is usually formed by sealing a liquid crystal, in the space made by putting a spacer between two pieces of substrate. The transparent electrode layer is formed on the substrate as a transparent film including an electric conductive substance. Further, a gas barrier layer, a hard coat layer or an undercoat layer (used for adhesion of the transparent electrode layer) may be applied on the liquid crystal cell. These layers are usually applied on the substrate. The thickness of the substrate for the liquid crystal cell is generally from 50 μm to 2 mm. The optical compensation sheet that has a double refraction property is used to eliminate coloration occurring on a display screen of the liquid crystal display device, or to improve viewing angle characteristics. The cellulose acylate film of the present invention itself may be used as an optical compensation sheet. In addition, an anti-reflection layer, an anti-glare layer, a λ/4 layer may be disposed, and a function may be given by processing as a biaxial oriented cellulose acylate film. Further, to improve viewing angle of a liquid crystal display devise, a laminate film of a cellulose acylate film of the present invention and a film that exhibits birefringence opposite to the cellulose acylate film may be used as an optical compensation sheet. The term “opposite” herein used means a reversal relation of positive/negative. The thickness of the optical compensation sheet is in the same range as the aforementioned preferable range of the film of the present invention.

The cellulose acylate film of the present invention can be applied to liquid crystal cells of various display modes. As for the display mode, proposed are TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned), and HAN (Hybrid Aligned Nematic) modes. In addition, there are proposals of display modes that are obtained by orientation dividing of the aforementioned display modes. The cellulose acylate film of the present invention is effective in liquid crystal display devices with any display mode. Further, the cellulose acylate film is effective in any of transparent-type, reflection-type, and semitransparent-type liquid crystal display devices.

The cellulose acylate film of the present invention can be used as a support for an optical compensation sheet that is used in TN type liquid crystal display devices having the liquid crystal cell of TN mode. The TN mode liquid crystal cell and the TN-type liquid crystal display device are well known for a long time. The optical compensation sheet that is used in TN-type liquid crystal display devices is described in, for example, JP-A-3-9325, JP-A-6-148429, JP-A-8-50206, and JP-A-9-26572, and also described in, for example, papers authored by Mori, et al. (Jpn. J. Appl. Phys., Vol. 36 (1997), p. 143, and Jpn. J. Appl. Phys., Vol. 36 (1997), p. 1068).

The cellulose acylate film of the present invention may be used as a support for an optical compensation sheet that is employed in STN-type liquid crystal display devices installing a STN mode liquid crystal cell. In STN-type liquid crystal display devices, generally, cylindrical shape mesomorphism molecules in the liquid crystal cell is twisted in the range of 90 to 360 degrees, and the product (And) of both refractive index anisotropy (Δn) and cell gap (d) of the cylindrical shape mesomorphism molecular is in the range of 300 to 1,500 nm. Regarding optical compensation sheets used for the STN type liquid crystal display devices, JP-A-2000-105316 describes in detail.

The cellulose acylate film of the present invention is particularly advantageously used as a support for an optical compensation sheet that is used in the VA-type liquid crystal display devices installing a VA mode liquid crystal cell. It is preferred that the Re retardation value and the Rth retardation value of the optical compensation sheet that is used in the VA-type liquid crystal display device are controlled to the range of from 0 to 150 nm and the range of from 70 to 400 nm, respectively. It is more preferable that the Re retardation value is in the range of from 20 to 70 nm. In an embodiment where two sheets of optically anisotropic polymer film are used in a VA-type liquid crystal display device, it is preferred that the Rth retardation value of the film is in the range of from 70 to 250 nm. In an embodiment where one sheet of optically anisotropic polymer film is used in a VA-type liquid crystal display device, it is preferred that the Rth retardation value is in the range of from 150 to 400 nm. The VA-type liquid crystal display device may have an orientation dividing system, as described in, for example, JP-A-10-123576.

The cellulose acylate film of the present invention can be advantageously used as a support for optical compensation sheet that is used in OCB type liquid crystal display devices having a liquid crystal cell of OCB mode, or used in HAN type liquid crystal display devices having a liquid crystal cell of HAN mode. It is desirable that, in the optical compensation sheet used for OCB type liquid crystal display device or HAN type liquid crystal display device, the direction where the magnitude of retardation becomes a minimum value exists neither in the optical compensation sheet plane nor in its normal direction. Optical properties of the optical compensation sheet for use in the OCB type liquid crystal display device or the HAN type liquid crystal display device are also determined by the optical properties of the optical anisotropy layer, by the optical properties of the support, and by the arrangement of the optical anisotropy layer and the support. Regarding the optical compensation sheet for use in the OCB type liquid crystal display device or HAN type liquid crystal display device, JP-A-9-197397 describes in detail. In addition, a paper by Mori et al. (Jpn. J. Appl. Phys., Vol. 38 (1999), p.2837) describes about it.

The cellulose acylate film of the present invention is advantageously used as an optical compensation sheet for the TN type, STN type, HAN type, or GH (Guest-host) type reflection type liquid crystal display devices. These display modes are well known for a long time. The TN type reflection liquid crystal display devices are described in, for example, JP-A-10-123478, WO 98/48320, and Japanese Patent No. 3022477. The optical compensation sheet for use in a reflection type liquid crystal display device is described in, for example, WO 00/65384.

The cellulose acylate film of the present invention can be advantageously used as a support for optical compensation sheet for use in ASM (Axially Symmetric Aligned Microcell) type liquid crystal display devices having a liquid crystal cell of ASM mode. The liquid crystal cell of ASM mode is characterized that a resin spacer adjustable with its position maintains the thickness of the cell. Other properties of the liquid crystal cell of ASM mode are similar to the properties of the liquid crystal cell of TN mode. Regarding liquid crystal cells of ASM mode and ASM type liquid crystal display devices, descriptions can be found in a paper of Kume et al. (Kume et al., SID98 Digest 1089 (1998)).

According to the present invention, can be provided a film prepared from a solution of cellulose acylate composed of a mixed ester esterified with both specific acyl and specific carbamoyl groups, which film is high in Tg, small in optical anisotropy, and low in moisture permeability. Further, according to the present invention, it is possible to provide a cellulose acylate film that is low in optical anisotropy, and suite for optical fields of application; specifically, for such as polarizing plates for liquid crystal image display devices, polarizing-plate protective films, phase-different films, viewing angle-enlarging films, front filters for plasma displays, front films for organic EL panels, image display elements, supports for liquid crystal display devices, and supports for polarizing plates. Further, according to the present invention, it is possible to provide a method of producing these optical films.

The present invention will be described in more detail based on the following examples, but the present invention is not limited thereto.

### EXAMPLES

### Example 1

### Synthesis of cellulose acetate.hexylcarbamate

Forty (40) grams of cellulose acetate (reagent manufactured by Aldrich Chemical Co., degree of substitution: 2.44, number average molecular weight: 50,000) was dissolved in a mixed solution of anhydrous acetone (40 ml) and anhydrous tetrahydrofuran (400 ml). To the solution, hexylisocyanate (22.4 g) was added, dropwise, at room temperature. Immediately after the addition, the reaction solution became gelled, but agitation was continued, and the solution became a viscous liquid. After agitation at an inner temperature of 40° C. for 3 hours, methanol was added, to re-precipitate a polymer component. Thus, a crude product was obtained. The air-dried crude product was re-dissolved in acetone, and methanol was added, to re-precipitate a crude product for purification. Yield was 33.3 g. The number-average molecular weight according to GPC (polystyrene conversion) was 62,000. Tg according to DSC was 183° C.

### Example 2

### Synthesis of cellulose acetate.octylcarbamate

Forty (40) grams of cellulose acetate (reagent manufactured by Aldrich Chemical Co., degree of substitution: 2.44, number average molecular weight: 50,000) was dissolved in a mixed solution of anhydrous acetone (40 ml) and anhydrous tetrahydrofuran (400 ml). To the solution, n-octylisocyanate (27.4 g) was added, dropwise, at room temperature. Immediately after the addition, the reaction solution became partially gelled, but agitation was continued, and the solution became a viscous liquid. After agitation at an inner temperature of 50° C. for 3 hours, methanol was added, to re-precipitate a polymer component. Thus, a crude product was obtained. The air-dried crude product was re-dissolved in acetone, and methanol was added, to re-precipitate a crude product for purification. Yield was 31.1 g. The number-average molecular weight according to GPC (polystyrene conversion) was 68,000. Tg according to DSC was 169° C.

### Example 3

### Synthesis of cellulose acetate.octadecylcarbamate

Forty (40) grams of cellulose acetate (reagent manufactured by Aldrich Chemical Co., degree of substitution: 2.44, number average molecular weight: 50,000) was dissolved in a mixed solution of anhydrous acetone (200 ml) and anhydrous tetrahydrofuran (400 ml). To the solution, n-octadecylisocyanate (52.0 g) was added, dropwise, at room temperature. Immediately after the addition, the reaction solution became partially gelled, but agitation was continued, and the solution became a viscous liquid. After agitation at an inner temperature of 50° C. for 5 hours, methanol was added, to re-precipitate a polymer component. Thus, a crude product was obtained. The air-dried crude product was re-dissolved in acetone, and methanol was added, to re-precipitate a crude product for purification. Yield was 26.7 g. The number-average molecular weight according to GPC (polystyrene conversion) was 112,000. Tg according to DSC was 182° C.

Tg's of the cellulose acetate carbamates synthesized in Examples 1 to 3 are shown in Table 2 together with those of cellulose acetate mixed esters and cellulose acylates, to make comparison. As is seen from Table 2, the cellulose acetate.carbamates according to the present invention were preferable in view of high Tg.

TABLE 2

| Sample | Mn | Mw | Tg(° C.) | Remarks |
|---|---|---|---|---|
| Cellulose acetate propionate | 74,000 | 282,000 | 132 | Comparative |
| (Ac: 0.18, Pr: 2.49) | | | | example |
| Cellulose acetate butyrate | 25,000 | 71,000 | 102 | Comparative |
| (Ac: 0.16, Bu: 2.53) | | | | example |
| Cellulose acetate hexanoate | 120,000 | 278,000 | 136 | Comparative |
| (Ac: 2.11, Hex: 0.56) | | | | example |
| Cellulose acetate octanoate | 107,000 | 210,000 | 126 | Comparative |
| (Ac: 2.4, Oct: 0.43) | | | | example |
| Cellulose acetate | 63,000 | 211,000 | Indefinite | Comparative |
| (Ac: 2.85) | | | | example |
| Cellulose butyrate | 268,000 | 854,000 | 87 | Comparative |
| (Bu: 2.83) | | | | example |
| Cellulose acetate hexylcarbamate | 62,000 | 130,000 | 183 | This |
| (Ac: 2.4, Hexc: 0.4) | | | | invention |
| Cellulose acetate octylcarbamate | 68,000 | 133,000 | 169 | This |
| (Ac: 2.4, Octc: 0.4) | | | | invention |
| Cellulose acetate octadecylcarbamate | 112,000 | 206,000 | 182 | This |
| (Ac: 2.4, Ocd: 0.4) | | | | invention |

Note:
The description in parenthesis after compound name in the column of “sample” indicates a substitution degree by each group.

### Example 4

### (1) Preparation of cellulose acylate solution

To a 400-liter stainless steel dissolving tank with an agitating blade and a flow of cooling water circulating along its outer periphery, were gradually added a cellulose acylate powder or cellulose triacetate A powder as described in Table 3 together with a solution of the following mixed solvents, while they were well stirred, to make a dispersion of the powder. Thus, the powder mixture was prepared to become a whole content of 200 kg. (The cellulose triacetate A was a powder having the following properties: degree of substitution 2.80; viscosity average polymerization degree 300; substitution degree of 6-position by acetyl group 0.91; acetone extractable matter 7 mass %; ratio of weight-average molecular weight to number-average molecular weight 2.3; Tg 160° C.; heat of crystallization 6.2 J/g; moisture content 0.2 mass %; viscosity of a 6 mass % dichloromethane solution 305 mPa.s; amount of residual acetic acid 0.1 mass % or less; Ca content 65 ppm; Mg content 26 ppm; Fe content 0.8 ppm; sulfate ion content 18 ppm; yellow index 1.9; free acetic acid 47 ppm; and average particle size 1.5 mm with standard deviation 0.5 mm.) The percentage of moisture content of each of methyl acetate, butanol, acetone, methanol, and ethanol that were used as a solvent, was 0.2 mass % or less. First, the powder of cellulose acylate was placed in a dispersion tank. After reducing pressure inside the tank to 1300 Pa, the powder was dispersed for 30 minutes under conditions of agitation by an agitator with a dissolver-type eccentric shaft at an agitation shearing speed of an initial peripheral speed of 15 m/sec (shearing stress 5×10⁴ kgf/msec²), and a center shaft with an anchor blade at a running peripheral speed of 1 m/sec (shearing stress 1×10⁴ kgf/m/sec²). The initial temperature of the dispersion was 25° C., and the final ultimate temperature was regulated to 35° C. by flowing cooling water. After the dispersing was terminated, such high-speed agitation was stopped, but slow agitation was continued for 100 minutes at a peripheral speed of the anchor blade of 0.5 m/sec, to thereby swell the cellulose acylate. Until the completion of swelling, pressurization was carried out with nitrogen gas, so that pressure inside the tank became 0.12 MPa. The oxygen concentration inside the tank at the same time was controlled to be less than 2 vol %. Thereby the inside of the tank was kept at the state no danger of explosion. The moisture content of the dope was confirmed to be 0.2 mass % or less. The composition of the cellulose acylate solution was as follows:

| | |
|---|---|
| Cellulose acylate | (20 mass parts) |
| Methyl acetate | (64.8 mass parts) |
| Acetone | (6.4 mass parts) |
| Ethanol | (6.4 mass parts) |
| Butanol | (3.2 mass parts) |

Plasticizer A (dimethylol propane tetraacetate)
   (1 mass part)
Plasticizer B (triphenyl phosphate)
   (1 mass part)
Plasticizer C (biphenyl diphenyl phosphate)
   (0.2 mass part)
UV absorbing agent a (2,4-bis-(n-octylthio)-6-(4-hydroxy-3,5-di-tert-butylanilino)-1,3,5-triazine)
   (0.2 mass part)
UV absorbing agent b (2-(2′-hydroxy-3′,5′-di-tert-butylphenyl)-5-chlorobenzotriazole)
   (0.2 mass part)
UV absorbing agent c (2-(2′-hydroxy-3′,5′-di-tert-amylphenyl)-5-chlorbenzotriazole)
   (0.2 mass part)
Fine particles (silicon dioxide (particle size 20 nm); Mohs' hardness, about 7)
   (0.05 mass part)
Ethyl citrate ester (a mixture of monoester and diester (mixing ratio 1:1))
   (0.04 mass part).

The un-homogeneous gel solution thus obtained was transported by means of a screw pump having an axial center section warmed to 30° C., and then it passed through a cooling zone, with cooling from the outer periphery of the screw, so that the liquid temperature was lowered to −75° C. in a period of 3 minutes. The cooling was carried out with a coolant cooled to −80° C. by a refrigerator. Then, the solution thus obtained by cooling was warmed to 35° C. during transportation with the screw pump, to transfer the warmed solution to a stainless steel vessel. After stirring at 50° C. for 2 hours to make the solution homogeneous, the resultant solution was filtered, with a filter of 0.01 mm in terms of absolute filtration accuracy (#63 (trade name), manufactured by Toyo Roshi Kaisha, Ltd.), and then with a filter of 2.5 μm in terms of absolute filtration accuracy (FH025 (trade name) manufactured by Pall Corporation). The thus-obtained cellulose acylate solution, after having been warmed to 110° C. and pressed at 1 MPa in the warming section and the pressing section of the transportation pipe, was released to the atmosphere of an ordinary pressure (about 0.1 MPa), to thereby evaporate organic solvents. Thus, a solution of cellulose acylate cooled to 40° C. and having a concentration of 24.0% by mass was obtained. Further, 2% by mass of butanol, based on solid content of cellulose acylate, was added, gradually, to the solution, with vigorous stirring, to obtain a homogeneous solution. Characteristics of the solution obtained were as follows:
Viscosity (40° C.): 120 Pa.s;
Dynamic storage elastic modulus (15° C.): 3,800 Pa;
Dynamic storage elastic modulus (−5° C.): 35,000 Pa;
Dynamic storage elastic modulus (−50° C.): 240,000 Pa; and
Association polymerization degree: 2.8 to 3.2 millions.

### (2) Production of cellulose acylate Film

The cellulose acylate solution (50° C.) filtered as mentioned above was cast, through a casting die head, on a mirror surface stainless support, forming by itself a drum of 3 m in diameter. At this time, the temperature of the support was set at −5° C. As the die head, an analog of the form described in JP-A-11-314233 was used. The casting speed was set at 75 m/min, and the casting width was set to 200 cm. The space temperature in the casting section was set at 15° C. A cellulose acylate film, coming by a turn of the drum after casting, was peeled from the drum at a point 50 cm in front of the casting section. Thereafter, both ends of the web were clipped with a pin tenter. Then, the cellulose acylate film held with the pin tenter was transported to a drying zone. As an initial drying, dry air at 45° C. was blown. Further, the film was dried at 110° C. for 5 minutes, and then at 145° C. for 10 minutes (the film temperature was about 140° C.), to obtain an 80-μm-thick cellulose acylate film. Both ends of the thus-obtained sample were cut by 3 cm. Then, after knurling of 100 μm in height in the section of 2 to 10 mm from the end, the sample was wound in the form of a roll.

### (3) Results

(Evaluation)

Chemical properties and physical properties of the aforementioned cellulose acylate solutions and films were measured and calculated.

(i) In-Plane Retardation Value (Re) of Film

In-plane retardation was measured according to the method described in JP-A-2001-247717, column 12, lines 4 to 20. In the present invention, the smaller the Re value, the more preferable the film is.

(ii) Thickness-Direction Retardation Value (Rth) of Film

Thickness-direction retardation was measured according to the method described in JP-A-2001-247717, column 12, lines 21 to 37. In the present invention, the smaller the Rth value, the more preferable the film is.

(iii) Stability of the Solution

The cellulose acylate solution was left standing still at 23° C., to observe change in the state of the solution. Evaluation was performed by classifying into the following ranks according to the visually observed state of the solution.
A: Transparency and homogeneity are kept even, for a period of 10 days.
B: Transparency and homogeneity are observed immediately after preparation of the solution, but a phase separation occurs over 1 day.
C: The solution becomes a non-uniform slurry from immediately after its preparation, and does not change further into a solution with transparency and homogeneity.
   (iv) Transparency of the Film

The sample film was visually observed to examine the presence of whitening.

(v) Stripping Property of the Film

The stripping property was measured according to the method described in JP-A-2001-247717, column 13, line 33 through column 14, line 7. Evaluation was performed by classifying into the following ranks according to the easiness of the stripping:
A: The film can be stripped within 20 sec.
B: The film cannot be stripped within 20 sec. Resultantly, a leftover of the film generates.
   (vi) Coefficient of Water Permeability

Moisture permeability was measured under the conditions of 60±2° C.×95±5%RH according to JISL1099 (A-1 method). Coefficient of water permeability was indicated using the unit of g/m²·24 hr, with normalizing a film thickness to be 100 μm.

TABLE 3

| | | | | Stability | | | |
|---|---|---|---|---|---|---|---|
| Sample | | | | of the | | Stripping | Water |
| No. | Solution | Re | Rth | solution | Transparency | property | permeability |
| 101 | Cellulose | 3 | 90 | A | Good | A | 1250 |
| | triacetate A | | | | | | |
| 102 | Cellulose | 2 | 45 | A | Good | A | 1100 |
| | acetate propionate | | | | | | |
| | (Ac: 0.18, Pr: 2.49) | | | | | | |
| 103 | I-12 | 2 | 30 | A | Good | A | 740 |
| 104 | I-14 | 2 | 35 | A | Good | A | 620 |
| 105 | I-24 | 1 | 25 | A | Good | A | 600 |
| 106 | I-15 | 2 | 21 | A | Good | A | 710 |
| 107 | I-21 | 2 | 32 | A | Good | A | 610 |
| 108 | I-44 | 3 | 28 | A | Good | A | 580 |
| 109 | I-61 | 3 | 33 | A | Good | A | 880 |
| 110 | I-62 | 3 | 39 | A | Good | A | 700 |
| 111 | I-63 | 2 | 38 | A | Good | A | 790 |
| 112 | I-26 | 1 | 28 | A | Good | A | 680 |
| 113 | I-17 | 2 | 26 | A | Good | A | 660 |
| 114 | I-65 | 2 | 39 | A | Good | A | 780 |
| 115 | Cellulose | — | — | — | Whitening | — | — |
| | acetate.octadecylcarbamate | | | | | | |
| | (Ac: 0.2, Ocd: 2.5) | | | | | | |

Note:
The description in parenthesis after compound name in the column of “Solution” indicates a substitution degree of each group.

As is apparent from the results shown in Table 3, the cellulose films of the present invention had such preferable properties that not only coefficient of water permeability and the Rth value were lower than those of the comparative examples (Samples 101 and 102), but also there was no whitening of the film observed and they were excellent in solution stability, transparency, and stripping property.

### Example 5

A solution (5-1) of cellulose triacetate A was prepared in the same manner as the method described in “(1) Preparation of cellulose acylate solution” of Example 4. To the solution, methyl acetate was further added in an amount of 10 mass % of the whole, to prepare a diluted cellulose triacetate solution (solution B).

A co-cast cellulose acylate film was obtained by multi-layer co-casting of the cellulose acylate solutions (103 to 107) of Example 4 as inner layers and the cellulose triacetate solution (solution B) on both sides of the inner layers, according to the co-casting method described in JP-A-6-134993. The film thickness was controlled so that each outer layer thickness became 3 μm and the inner layer thickness became 34 μm, resulting in the total thickness of 40 μm. The surface condition of Sample 6-1 thus obtained was further improved that the surface was smooth and flat (with no irregularity). Accordingly, it is apparent that the co-cast film is also an excellent embodiment of the present invention.

### Example 6

An elliptically polarizing plate (Sample 604) was prepared in the same manner as described in Example 1 of JP-A-11-316378, except that the first transparent support was replaced by a cellulose acylate film equivalent to Sample 104 that was obtained in Example 4 of the present specification (however, the film thickness thereof was regulated to be 100 μm). The elliptically polarizing plate thus obtained was excellent in optical properties. Accordingly, it is apparent that in the production processes according to the present invention, a cellulose acylate film is a preferable embodiment in which no problem arises even if the film is applied to an elliptically polarizing plate.

### Example 7

An optical compensation filter film sample (Sample 704) was prepared in the same manner as in Example 1 of JP-A-7-333433, except that the cellulose triacetate (manufactured by Fuji Photo Film Co., Ltd.) in Example 1 of JP-A-7-333433 was replaced by the cellulose acylate film of Sample 104 in Example 4 in the present specification. The obtained filter film was excellent in the whole round of viewing angle. Accordingly, it is understood that a cellulose acylate film of the present invention is excellent in optical uses.

### Example 8

The Sample 104 in Example 4 of the present specification was applied to each of the followings: a liquid crystal display device described in Example 1 of JP-A-10-48420, an optically anisotropic layer containing discotic liquid crystal molecules described in Example 1 of JP-A-9-26572, an orientation membrane having a coating of polyvinyl alcohol, a VA-type liquid crystal display described in FIGS. 2 to 9 of JP-A-2000-154261, and an OCB-type liquid crystal display described in FIGS. 10 to 15 of JP-A-2000-154261. Excellent performances were obtained in each application. From these results, it is apparent that the present invention can be used for application to various kinds of optical films.

### Example 9

Sample 904 was prepared in the same manner as Sample 104 in Example 4, except that the solvent for cellulose acylate was replaced by a mixed solvent of dichloromethane, methanol, and butanol (270 parts by mass of dichloromethane, 70 parts by mass of methanol, 7 parts by mass of butanol, based on 100 parts by mass of cellulose triacetate, respectively). It was confirmed that the cellulose acylate film was low in coefficient of water permeability and Rth, that the cellulose film was observed no whitening; and in addition, the cellulose film also had preferable characteristics in solution stability, transparency, and stripping property.

Having described our invention as related to the present embodiments, it is our intention that the invention not be limited by any of the details of the description, unless otherwise specified, but rather be construed broadly within its spirit and scope as set out in the accompanying claims.

1. A cellulose acylate film for optical use, comprising a cellulose acylate (a),
wherein the cellulose acylate (a) is a mixed ester esterified with both acyl and carbamoyl groups, in which the acyl group is an aliphatic acyl group having 2 to 22 carbon atoms, and the carbamoyl group is an alkyl carbamoyl group having 2 to 24 carbon atoms.

2. The cellulose acylate film for optical use according to claim 1, wherein the total sum of substitution degrees of hydroxyl groups at the 2-, 3-, and 6-positions of the recurring unit of the cellulose acylate (a) is in the range of from 2.40 to 3.00

3. The cellulose acylate film for optical use according to claim 1, wherein, in the cellulose acylate (a), a substitution degree of hydroxyl group by the acyl group is in the range of from 1.00 to 2.95, and a substitution degree of hydroxyl group by the carbamoyl group is in the range of from 0.05 to 2.00.

4. The cellulose acylate film for optical use according to claim 1, wherein, in the cellulose acylate (a), the acyl group has 2 to 8 carbon atoms and the carbamoyl group has 4 to 22 carbon atoms.

5. The cellulose acylate film for optical use according to claim 1,
wherein the cellulose acylate film comprises at least two components selected from the group consisting of the cellulose acylate (a), a cellulose acylate (b), and a polymer blend of the cellulose acylate (a) and the cellulose acylate (b), in which the cellulose acylate (b) is a cellulose acylate esterified with an acyl group having 2 to 12 carbon atoms; and
wherein the cellulose acylate film has a laminated structure constituted by independent layers of each individual component.

6. The cellulose acylate film for optical use according to claim 5, wherein the cellulose acylate (b) is selected from the group consisting of a cellulose acetate, a cellulose acetate propionate, and a cellulose acetate butylate.

7. The cellulose acylate film for optical use according to claim 1, wherein the cellulose acylate film has a layer that contains a component comprising a blend of the cellulose acylate (a) and a cellulose acylate (b) esterified with an acyl group having 2 to 12 carbon atoms.

8. A method of producing a cellulose acylate film, comprising: casting a dope of a cellulose acylate dissolved in a solvent,
wherein the cellulose acylate is a cellulose acylate (a) esterified with both acyl and carbamoyl groups, in which an acyl group is an aliphatic acyl group having 2 to 22 carbon atoms, and a carbamoyl group is an alkyl carbamoyl group having 2 to 24 carbon atoms.

9. The method of producing a cellulose acylate film according to claim 8,
wherein the cellulose acylate film comprises at least two components selected from the group consisting of the cellulose acylate (a), a cellulose acylate (b), and a polymer blend of the cellulose acylate (a) and the cellulose acylate (b), in which the cellulose acylate (b) is a cellulose acylate esterified with an acyl group having 2 to 12 carbon atoms and,
wherein the cellulose acylate film is formed by co-casting of 2 to 5 layers.

10. An optical film, which comprises the cellulose acylate film for optical use according to claim 1.

11. A polarizing plate, which comprises the cellulose acylate film for optical use according to claim 1.

12. An image display device, which comprises the cellulose acylate film for optical use according to claim 1.

13. A liquid crystal display device, which comprises the cellulose acylate film for optical use according to claim 1.

14. An organic electroluminescence display device, which comprises the cellulose acylate film for optical use according to claim 1.

15. A silver halide photosensitive material, which comprises the cellulose acylate film for optical use according to claim 1.
